(19) United States
(12) Patent Application Publication
(10) Pub. No.: US 2005/0153774 A1
(43) Pub. Date: Jul. 14, 2005

(54) Gaming machine and gaming system

(75) Inventor: Kazuo Okada, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/008,382

(22) Filed: Dec. 10, 2004

(30) Foreign Application Priority Data
Dec. 10, 2003 (JP) 2003-412265
Aug. 5, 2004 (JP) 2004-229883

(51) Int. Cl. G06F 17/00

(52) U.S. Cl. 463/25

(57) ABSTRACT

The present invention provides a gaming machine which is configured to allow a player to pay tax without waiting for the payout of coins or the like for a long time even when the player wins a win which requires tax payment and a gaming system which includes such a gaming machine and a gaming server. In a slot machine which performs a variable display of pseudo reels on a liquid crystal display panel, an approval or disapproval of a win on the combination of symbols which are stopped on an activated payline for determining the approval/disapproval of the win is determined based on a control of a main CPU. When the win is approved, the necessity of tax payment on the approved win is determined and, when it is determined that tax payment is necessary, a tax amount corresponding to the award is deducted from the award which corresponds to the win.

### CROSS-REFERENCES TO THE RELATED APPLICATIONS

This application is based upon and claims the priority from a prior Japanese patent application No. 2003-412265, filed in Japan on Dec. 10, 2003 and a prior Japanese patent application No. 2004-229883, filed in Japan on Aug. 5, 2004, entire contents of which are incorporated herein by reference.

This application is related to a co-pending U.S. patent application referred to as a prior Japanese patent application No. 2003-415130 filed in Japan on Dec. 12, 2003.

### BACKGROUND OF THE INVENTION

1. Field of the Invention

The present invention relates to a gaming machine and a gaming system having a gaming server for paying out an award corresponding to a win of a game.

2. Related Art

Conventionally, as a gaming machine which pays out medium which is used in a game such as medals, coins or the like (hereinafter referred to as “coins”) corresponding to a content of a win of the game, there has been known various gaming machines including a card gaming machine which advances the game in such a manner that card images which indicate cards of a card game are displayed and the display of the respective card images is changed in accordance with operation inputting by a player and a slot machine. Among these playing machines, with respect to the slot machine (see Japanese Laid-open Patent Publication 2000-42169), there has been known a slot machine which includes a plurality of reels with symbols attached to outer peripheral surfaces thereof (a mechanical reel) and a slot machine which includes a plurality of reels which are displayed by images. In both slot machines, when the player performs a predetermined control, the respective reels are rotated or scrolled and, at a point of time that the respective reels are stopped, depending on the combination of symbols of the respective reels which arrive at a predetermined activated payline, whether the player wins a win in the play (also referred to as “game”) and a mode when the player wins the play (wining mode) are determined.

In the slot machine, although the number of coins to be paid out differs depending on the win modes, among these win modes, there exists the win mode which constitutes a big win (big winnings) in which an extremely large number of coins are paid out compared to ordinary payouts. Since the player receives the payout of large amount of money from the gaming machine when the player wins such big winnings, the player plays a game while expecting the big winnings.

### SUMMARY OF THE INVENTION

With respect to the above-mentioned gaming machines, among the conventional gaming machines, there have been known several machines which enhance the interest of the player with big wins.

However, depending on the country or the region where the gaming machines are installed, there exists legislation which requests a player to pay tax with respect to an amount of money which the player is expected to receive as the payout when the player wins big winnings (a big win) whose payout is equal to or more than 1200 dollars. In this case, the gaming machine assumes a so-called locked state in which the gaming machine stops its operation without paying out coins with respect to the big win that the player wins and the player has to wait for the payout until an attendant of the gaming arena arrives at the spot to take necessary procedures such as the preparation of documents necessary for the payment of tax (for approximately 5 to 10 minutes, for example). Accordingly, in the conventional gaming machine, although the player expects the payout of a large amount of money after winning the big win, the player has to wait for the payout until the procedure of tax payment which is different from the gaming in nature is concluded. Accordingly, the conventional gaming machine is less than optimum for allowing the player to maintain his/her interest in the game.

The present invention has been made to overcome the above-mentioned drawbacks and it is an object of the present invention to provide a gaming machine and a gaming system which has a gaming machine and a gaming server which can perform the payment of tax without requesting a player to wait for the payment even when the player wins a big win which requires payment of tax.

(1) To overcome the above-mentioned drawback, the present invention provides a gaming machine which pays out an award to a player corresponding to a win of a game, wherein the gaming machine includes win approval/disapproval determination means which determines an approval or a disapproval of the win of the game; tax payment requirement determination means which determines the necessity of tax payment on the win which is approved by the win approval/disapproval determination means; and withholding tax means which deducts an amount of tax corresponding to the award corresponding to the win from the award when tax payment requirement determination means determines that tax payment is necessary.

The gaming machine, when it is determined that the win requires tax payment, can deduct the amount of tax corresponding to the award corresponding to the win from the award.

(2) Further, the present invention provides a gaming machine which is a slot machine.

The slot machine, when it is determined that the win requires tax payment, can deduct the amount of tax corresponding to the award corresponding to the win from the award in accordance with the taxation conditions suitable for the player himself/herself.

(3) Further, it is preferable that the gaming machine includes selection means which allows the player to select between tax payment using the withholding tax means and tax payment without using the withholding tax means.

Due to such a provision, the player can select either one from tax payment using the withholding tax means and tax payment without using the withholding tax means.

(4) It is preferable that the gaming machine further includes tax paying will inputting means which allows the player to input his/her will to pay the tax using the withholding tax means.

Due to such a provision, the player can input his/her will to pay the tax to the gaming machine in a mode that the gaming machine deducts the amount of tax.

(5) It is further preferable that the gaming machine includes player's information generation means which generates the player's information for recording the player who pays tax using the withholding tax means, and player's information storage means which stores the player's information generated by the player's information generation means.

Due to such a provision, it is possible to record the player who pays tax in a state that the gaming machine deducts the amount of tax.

(6) Still further, it is preferable that the gaming machine includes tax amount information outputting means which outputs tax information indicative of the amount of tax corresponding to the award.

Due to such a provision, it is possible to take out the tax amount information outside the gaming machine and to use the tax amount information in the tax payment procedure at a gaming arena.

(7) Further, it is preferable that that gaming machine includes tax rate setting means which sets a tax rate for obtaining the amount of tax corresponding to the award, and the withholding tax means requests the amount of tax using the tax rate set by the tax rate setting means.

(8) Still further, it is preferable that the gaming machine includes tax rate setting means which sets a tax rate for obtaining the amount of tax corresponding to the award, and the tax rate setting means gradually increases the tax rate corresponding to the increase of the award.

Due to such a provision, it is possible to reduce the tax burden amount of a low-price award receiver than a high-price award receiver.

(9) The present invention provides a gaming system which is constituted by connecting a gaming machine which pays out an award to a player corresponding to a win of a game and a gaming server, wherein the gaming machine includes win approval/disapproval determination means which determines an approval or a disapproval of the win of the game; tax payment requirement determination means which determines the necessity of tax payment on the win which is approved by the win approval/disapproval determination means; withholding tax means which deducts an amount of tax corresponding to the award corresponding to the win from the award when the tax payment requirement determination means determines that the tax payment is necessary; and transmission means which transmits tax amount information indicative of a tax amount corresponding to the award to a gaming server, wherein the gaming server includes tax amount information reception means which receives tax amount information from the gaming machine and tax amount calculation means which calculates a tax payment amount based on the tax amount information which is received by the tax amount information reception means.

In this gaming system, when it is determined that the win requires tax payment, tax payment is performed using the gaming machine in a state that the tax amount is deducted from the award corresponding to the win. Further, it is possible to calculate the tax payment amount based on the tax amount information indicative of the tax amount using the gaming server.

(10) Further, it is preferable that, in the gaming system, the gaming machine includes tax rate setting means which sets a tax rate for obtaining the amount of tax corresponding to the award, and the withholding tax means requests the amount of tax using the tax rate set by the tax rate setting means.

(11) Further, it is preferable that, in the gaming system, the gaming machine includes tax rate setting means which sets a tax rate for obtaining the amount of tax corresponding to the award, and the tax rate setting means gradually increases the tax rate corresponding to the increase of the award.

(12) Further, the present invention provides a gaming system in which the gaming machine is a slot machine.

According to this gaming system, with respect to the win which is determined to require tax payment, the player can pay the tax in a state that the tax amount is deducted from the award corresponding to the win in accordance with the taxation conditions suitable for the individual player using the slot machine. Further, it is possible to calculate the tax payment amount based on the tax amount information indicative of the tax amount using the gaming server.

(13) Further, the present invention provides a gaming system which is constituted such that taxation condition information is transmitted to the gaming machine from the gaming server and the withholding tax means deducts the amount of tax corresponding to the award corresponding to the win from the award in accordance with the taxation condition information.

(14) Further, the present invention provides a gaming system which is constituted such that the gaming machine transmits player's personal information and award information to the gaming server, the gaming server determines the taxation condition based on the player's personal information, and the withholding tax means obtains a tax amount corresponding to the award indicated by the award information and the award after tax which is obtained by deducting the amount of tax from the award in accordance with the taxation condition.

As described above in detail, according to the present invention, the gaming machine and the gaming system of the present invention can perform the payment of tax without requesting the player to wait for the payment even when the player wins a big win which requires payment of tax.

### BRIEF DESCRIPTION OF THE DRAWINGS

FIG. 1 is a perspective view showing the whole constitution of a slot machine which constitutes a gaming machine according to an embodiment of the present invention;

FIG. 2 is a system constitutional view showing the whole constitution of a gaming system according to the embodiment of the present invention;

FIG. 3 is a block diagram of the slot machine which substantially focuses on the inner constitution thereof;

FIG. 4 is a block diagram showing one example of the inner constitution of an image control circuit;

FIG. 5 is a block diagram showing one example of the inner constitution of a gaming server;

FIG. 6 is a flow chart showing operational steps of main processing from a start to an end of a game using the slot machine;

FIG. 7 is a flow chart showing operational steps of lottery processing;

FIG. 8 is a flow chart showing operational steps of tax payment processing;

FIG. 9 is a view showing one example of a display content of a tax payment selection screen;

FIG. 10 is a view showing one example of a display content of a tax payment confirmation screen;

FIG. 11 is a view showing steps of tax payment processing by manual tax payment;

FIG. 12 is a view showing steps of tax payment processing by adding automatic tax payment to manual tax payment;

FIG. 13 is a flow chart showing operational steps of tax payment processing in a gaming machine according to another embodiment;

FIG. 14 is a flow chart showing operational steps of tax rate setting processing in the gaming machine according to another embodiment;

FIG. 15 is a flow chart showing operational steps of main processing from a start to an end of a game using the slot machine according to an embodiment 2;

FIG. 16 is a flow chart showing operational steps of lottery processing according to the embodiment 2;

FIG. 17 is a flow chart showing operational steps of tax payment processing according to the embodiment 2;

FIG. 18 is a view showing one example of a display content of a tax payment selection screen according to the embodiment 2;

FIG. 19 is a view showing one example of a display content of a personal information inputting screen according to the embodiment 2;

FIG. 20 is a view showing one example of a display content of a tax payment confirmation screen according to the embodiment 2;

FIG. 21 is a view showing steps of tax payment processing by manual tax payment according to the embodiment 2;

FIG. 22 is a view showing steps of tax payment processing by adding automatic tax payment to manual tax payment according to the embodiment 2;

FIG. 23 is a view showing steps of information transmission and reception between a slot machine and a gaming server in one modification of the embodiment 2; and

FIG. 24 is a view showing steps of information transmission and reception between a slot machine and a gaming server in another modification of the embodiment 2.

### DESCRIPTION OF THE PREFERRED EMBODIMENTS

Embodiments of the present invention are explained in conjunction with attached drawings. In the drawings, identical elements are given same numerals and the overlapped explanation of these elements is omitted.

### Embodiment 1

(System Constitution of Gaming System)

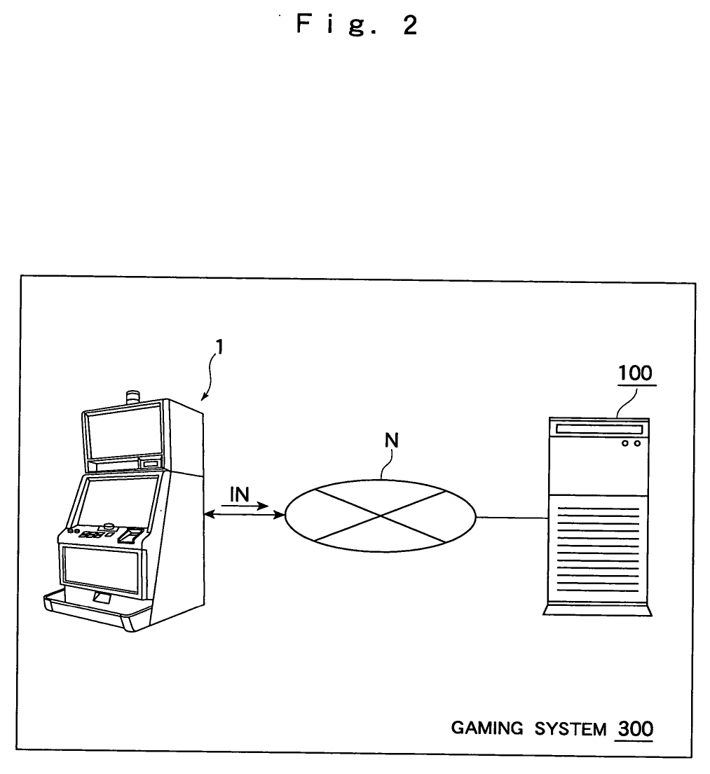

FIG. 2 is a system constitutional view showing the entire constitution of a gaming system 300 according to the embodiment 1 of the present invention. In the gaming system 300, a slot machine 1 and a gaming server 100 are connected via a network N (LAN: Local Area Network or Internet) so that the slot machine 1 and the gaming server 100 can be communicated with each other. This gaming system is configured such that taxation information “In” described later is transmitted to the gaming server 100 from the slot machine 1 via the network N.

(Whole Constitution of Slot Machine)

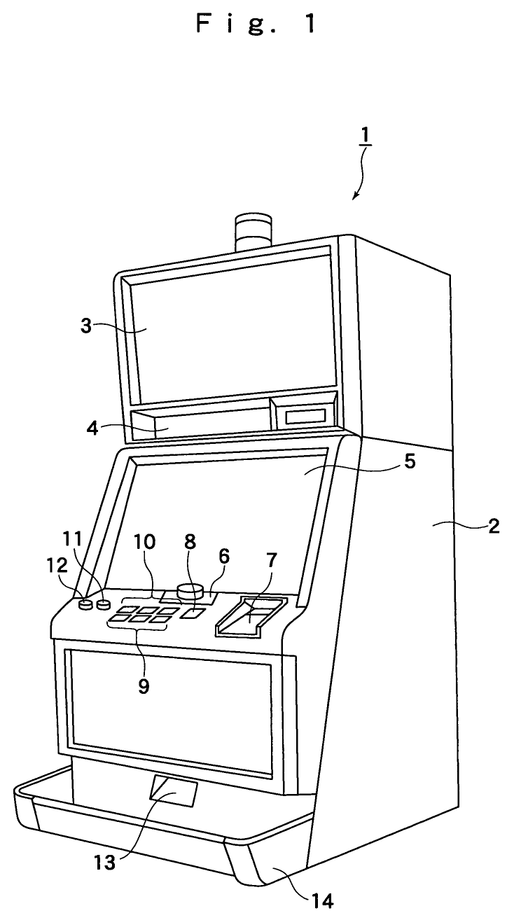

FIG. 1 is a perspective view showing the whole structure of the slot machine 1. The slot machine 1 constitutes a gaming machine according to this embodiment of the present invention and is configured to include variable display means which variably displays a plurality of symbols and displays a plurality of reels on the variable display means so as to allow a player to perform a game. The player determines whether he/she wins a win or not due to the combination of symbols which comes on an activated payline at a point of time that the respective pseudo reels are stopped. Here, the reels may be reels with symbols actually attached to outer peripheral surfaces thereof or may be the reels which are displayed by images.

In the slot machine 1, liquid crystal display panels 3, 4, 5 are arranged sequentially from above on a front surface of a cabinet 2. On the liquid crystal display panels 3, an image which is not directly relevant to the game (for example, a three-dimensional motion picture for game effect or the like which brings the excitant to a game) is displayed. An explanation of the manner of performing the game or the like is displayed on the liquid crystal display panels 4.

On the liquid crystal display panels 5, a plurality of pseudo reels are displayed, wherein the respective pseudo reels can symbols thereon (including scroll display).

Further, the cabinet 2 is provided with a coin insertion slot 6 for allowing inserting of coins and a bill insertion slot 7 for allowing inserting of bills for betting on the game on a lower side of the liquid crystal display panel 5. Further, a spin button 8, a BET selection button 9, a line selection button 10, a stop button 11 and a payout button 12 are arranged on the cabinet 2 in the leftward direction from the bill insertion slot 7.

The spin button 8 is provided for inputting a start signal, wherein the player instructs the starting of the game with a control input of the player so as to start the variable display of the pseudo reels on the liquid crystal display panels 5. The BET selection button 9 serves to allow the player to input a BET selection signal for selecting and setting the number (for example, one coin, two coins, ten coins) of coins which become subjects of BET. The line selection button 10 serves to allow the player to input a payline selection signal for selecting a desired activated payline from a plurality of activated payline not shown in the drawing with a control input of the player. A stop button 11 serves to input a stop signal which instructs the stop of the pseudo reel on which a variable display is performed. A payout button 12 serves to allow the player to perform a switching control between a credit of the coins that the player has acquired and the payout of the coins. That is, when the credited coins exist, the player inputs a payout signal to pay out the coins. Further, the cabinet 2 is provided with a coin payout opening 13 and a coin tray 14 which stores paid-out coins therein on a bottom portion thereof.

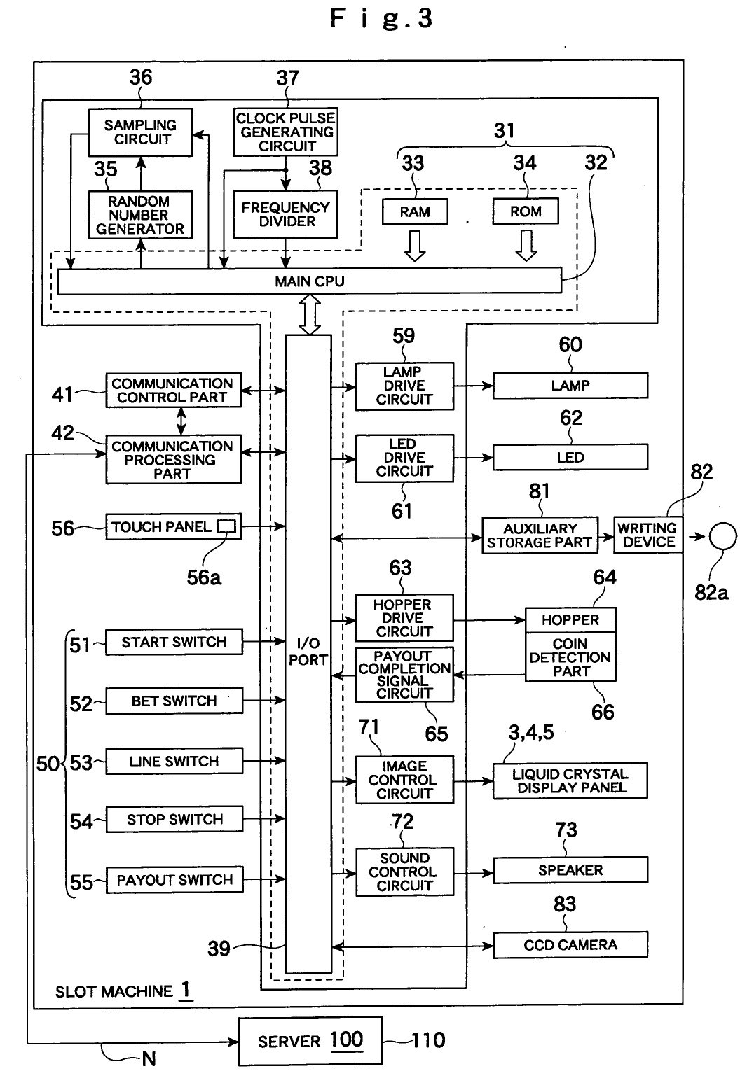

FIG. 3 is a block diagram of the slot machine 1 showing the inner constitution focusing the center thereof. The slot machine 1 includes a plurality of constitutional elements in which a microcomputer 31 constitutes a main constitutional element.

The microcomputer 31 includes a main CPU (Central Processing Unit) 32, a RAM (Random Access Storage) 33, and a ROM (Read Only Storage) 34. The main CPU 32 is operated in accordance with a program stored in the ROM 34, performs the inputting/outputting of signals with respect to other constitutional elements via an I/O port 39, and performs an operational control of the whole slot machine 1. Data and programs which are used at the time of operating the main CPU 32 are stored in the RAM 33. For example, random number values which are sampled by a sampling circuit 36 described later are temporarily held after starting the game and, at the same time, data including code numbers, symbol numbers and the like of the pseudo reels are stored. In the ROM 34, a program which the main CPU 32 executes and permanent data are stored. In case of the slot machine 1, a winning determination table, a symbol determination table, a stop table and a payout table which are described later are stored in the ROM 34.

Further, the slot machine 1 includes a random number generator 35, a sampling circuit 36, a clock pulse generating circuit 37, and a frequency divider 38. The random number generator 35 is operated in accordance with an instruction from the main CPU 32 and generates random numbers within a predetermined range. The sampling circuit 36, in accordance with the instruction from the main CPU 32, samples arbitrary random numbers out of the random numbers generated by the random number generator 35 and inputs the sampled random numbers to the main CPU 32. The clock pulse generating circuit 37 generates a reference clock for operating the main CPU 32, while the frequency divider 38 inputs signals obtained by dividing the frequency of the reference clock at a fixed cycle to the main CPU 32.

Further, the slot machine 1 includes a communication control part 41 and a communication processing part 42. The slot machine 1 also includes a switch input unit 50 and a touch panel 56.

The communication control part 41 is operated in accordance with an instruction from the main CPU 32 and controls the connection and disconnection of the communication with the gaming server 100. The communication processing part 42 is communication means which is operated in accordance with an instruction from the communication control part 41 and executes the transmission/reception of data performed via the network N. The communication processing part 42 is operated as the transmission means which transmits taxation information described later to the gaming server 100.

The switch input unit 50 includes a start switch 51, a BET switch 52, a line switch 53, a stop switch 54 and a payout switch 55. The start switch 51 inputs a start signal to the main CPU 32 upon detection of a control input of the spin button 8. The BET switch 52 inputs a BET selection signal to the main CPU 32 upon detection of a control input of the BET selection button 9. The line switch 53 inputs a line selection signal to the main CPU 32 upon detection of a control input of the line selection button 10. The stop switch 54 inputs a stop signal to the main CPU 32 upon detection of a control input of the stop button 11. The payout switch 55 inputs a payout signal to the main CPU 32 upon detection of a control input of the payout button 12.

A touch panel 56 is provided in a state that the touch panel 56 covers a display screen of the liquid crystal display panels 5, wherein the touch panel 56 detects a position of a portion where a finger of the player touches and inputs a position signal corresponding to the detected position to the main CPU 32. Further, in the touch panel 56, an image generation part 56a which generates image data of letters, symbols and the like (for example, signature directly written by the player or player's finger print inputted by the player described later) which are inputted using a predetermined pen (not shown in the drawing) is incorporated.

Further, the slot machine 1 includes a lamp drive circuit 59, a lamp 60, an LED drive circuit 61, an LED 62, a hopper drive circuit 63, a hopper 64, a payout completion signal circuit 65, and a coin detection part 66. Still further, the slot machine 1 includes an image control circuit 71, a sound control circuit 72 and a speaker 73.

The lamp drive circuit 59 outputs a signal for turning on the lamp 60 to the lamp 60 and blinks the lamp 60 during the performance of the game (for example a second game). Due to this blinking, a game effect is obtained. The LED drive circuit 61 controls the blinking display of the LED 62. The LED 62 performs the display of the number of credits, the display of acquired number of coins and the like. The hopper drive circuit 63 drives the hopper 64 in accordance with the control executed by the main CPU 32 and the hopper 64 performs an operation to payout coins so as to payout the coins from the payout opening 13. The coin detection part 66 counts the number of coins paid out from the hopper 64 and informs the payout completion signal circuit 65 of data on the counted number value. The payout completion signal circuit 65 receives the inputting of data of coin number values from the coin detection part 66 and inputs a signal which informs the payout completion of the coins to the main CPU 32 when the number value reaches the set number data.

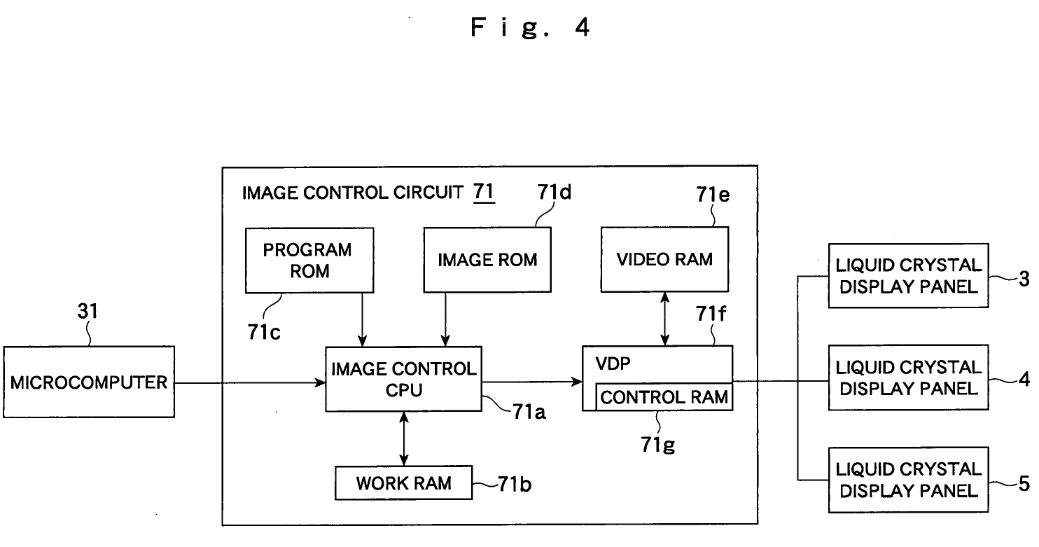

The image control circuit 71 controls images in the respective liquid crystal display panels 3, 4, 5 and displays various images of the pseudo reels or the like which can perform the variable display on the liquid crystal display panel 3, 4, 5. The image control circuit 71, as shown in FIG. 4, includes an image control CPU 71a, a work RAM 71b, a program ROM 71c, an image ROM 71d, a video RAM 71e and a VDP (Video Display Processor) 71f. The image control CPU 71a determines images (pseudo reels or the like) which are displayed on the liquid crystal display panels 3, 4, 5 in accordance with an image control program (relevant to the displays on the liquid crystal display panels 3, 4, 5) prestored in the program ROM 71c based on parameters set by the microcomputer 31. The work RAM 71b is constituted as temporary storage means which is used when the image control CPU 71a executes the image control program.

The program ROM 71c stores the image control program, various selection tables and the like. The image ROM 71d stores dot data for forming the images. The video RAM 71e is constituted as temporary storage means which is used for forming images by the VDP 71f. The VDP 71f includes a control RAM 71g and forms images corresponding to display contents of the respective liquid crystal display panels 3, 4, 5 determined by the image control CPU 71a and outputs the respective formed images to the liquid crystal display panels 3, 4, 5.

A sound control circuit 72 inputs vocal signals for outputting voices from a speaker 73 in the speaker 73. Sounds which excite the game are outputted from the speaker 73 at suitable times after starting the game, for example.

Further, the slot machine 1 includes an auxiliary storage part 81, a writing device 82 and a CCD camera 83. The auxiliary storage part 81 stores various data (for example, taxation information, player's information) which are used in the execution of the game and the tax payment processing which features the present invention and is operated as the players information storage means according to the present invention. The writing device 82 is operated in accordance with an instruction from the main CPU 32. That is, the writing device 82 is operated as output means which reads out and outputs data stored in the auxiliary storage part 81 and writes and stores the outputted data to a storage medium 82a such as a CD-R (Compact Disc Recordable), a CD-RW (Compact Disc Rewritable) or the like. The CCD camera 83 is operated as player's information generating means. That is, the CCD camera 83 takes a picture (records) a face of the player as described later using a CCD (Charge Coupled Device), generates image data of the photographed face as player's information for recording the player and, stores the image data in the auxiliary storage part 81. Here, it is sufficient for the slot machine 1 to generate information which can surely identify the player. Accordingly, besides the CCD camera 83, it may be possible to provide means which records a fingerprint, a vocal print or an iris of the player and generates the player's information based on them.

(Constitution of Gaming Server)

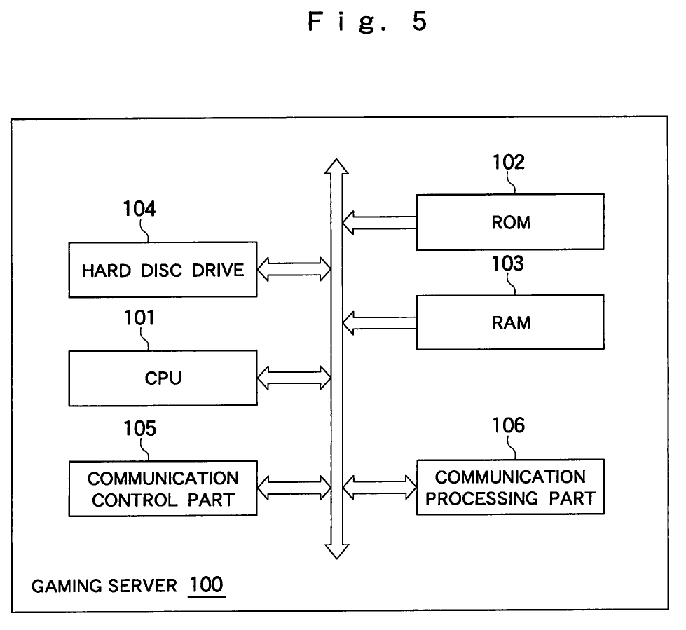

The gaming server 100 includes, as shown in FIG. 5, a CPU 101, a ROM 102, a RAM 103, a hard disc drive 104, a communication control part 105 and a communication processing part 106 and is configured to be communicable with the slot machine 1 via the network N.

The CPU 101 is operated in accordance with a program stored in the ROM 102 and controls an operation of the whole gaming server 100, and is operated as tax amount calculation means which features the present invention. In the ROM 102, a control program which the CPU 101 executes and permanent data are stored. In the RAM 103, data which is used for operating the CPU 101 is stored.

In the hard disc drive 104, data transmitted from the slot machine 1, that is, various data including the taxation information in this embodiment and the programs are stored. The communication control part 105 is operated in accordance with an instruction from the CPU 101 and controls the connection and disconnection of the communication with the slot machine 1. The communication processing part 106 is operated in accordance with an instruction from the communication control part 105 and executes the transmission/reception of data which are performed via the network N. This communication processing part 106 is operated as reception means which receives the taxation information “In” from the slot machine 1.

(Content of Operation of Gaming System)

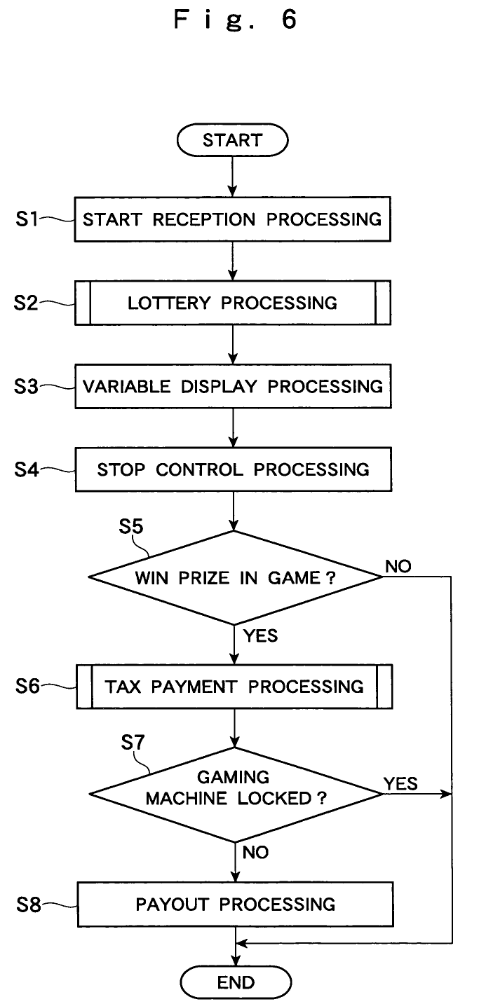

Next, the content of the operation of the gaming system 300 having the above-mentioned constitution is explained in conjunction with flow charts shown in FIG. 6 to FIG. 8.

FIG. 6 is the flow chart showing operational steps of main processing from a start to an end of the game performed in the slot machine 1. Here, in FIG. 6 to FIG. 8, steps are abbreviated as “S”.

As shown in FIG. 6, when the slot machine 1 starts the main processing, at the time of starting the game, the start reception processing is performed in step 1 and the lottery processing is performed in the succeeding step 2.

Firstly, when the flow advances to the start reception processing in step 1, the slot machine 1 receives an operation for starting the game from the player in accordance with the control from the main CPU 32. The player starts the game. To start the pseudo reels (to allow the pseudo reels to perform variable display), first of all, the player inserts the number of coins which the player bets in one game into the coin insertion slot 6, sets the number of coins which the player bets in one game by controlling BET selection button 9 and, further, sets the activated payline by controlling the line selection button 10. Subsequently, a spin button 8 is controlled (this control being referred to as “start control” hereinafter). Due to this start control, the start signal is inputted to the main CPU 32 from the start switch 51 (in case of the credit, the BET selection signal is inputted from the BET switch 52).

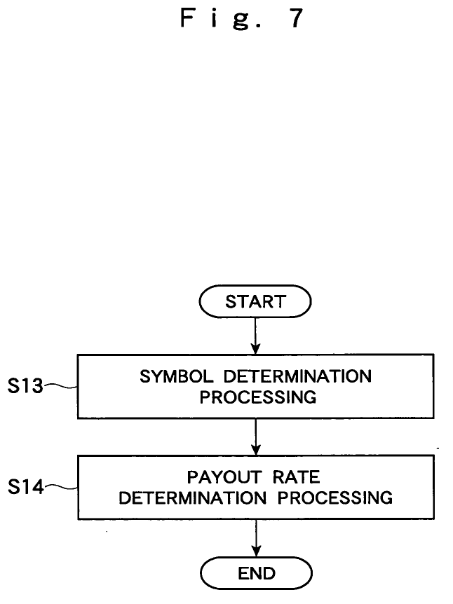

Next, the flow advances to step 2 and the lottery processing is performed. When the lottery processing is started, the flow advances to step 13 shown in FIG. 7 and the symbol determination processing is performed by the main CPU 32. In this symbol determination processing, the main CPU 32 determines the symbols which are stopped at the set activated payline for respective pseudo reels.

Then, in the lottery processing, when the main CPU 32 detects the start control of the player in response to an input signal from the start switch 51, instructs the random number generator 35 to generate the random numbers within a fixed range upon receiving the detection (that is, with this game start as an opportunity). Further, the main CPU 32 instructs the sampling circuit 36 to sample arbitrary random numbers output of the random numbers generated by the random number generator 35. When the random numbers are sampled, the main CPU 32 sets the random numbers in a search key and refers to a symbol determination table (a table which stores code No of symbols and the random numbers in an associated manner) not shown in the drawing which is stored in the ROM 34, and acquires the code numbers of the corresponding symbols.

Next, the acquired code numbers are set in the search key and a stop table (a table which stores the code No of symbols and the symbols in an associated manner) not shown in the drawing is referred and the corresponding symbols are retrieved with respect to respective pseudo reels.

Then, in the slot machine 1, the above-mentioned sampling of random numbers and the search of the symbol determination table and stop table are performed for the respective pseudo reels. Further, when the symbols are determined with respect to the respective pseudo reels, the reel stop positions for stopping the symbols on the activated payline are determined.

Further, the main CPU 32 advances to step 14 and refers to a payout table not shown in the drawing, and determines a magnification of payout (a payout ratio) corresponding to a symbol pattern. Here, the payout ratio per one coin corresponding to each symbol pattern is registered to the payout table. Due to the above-mentioned operation, the lottery processing is finished.

Next, the flow advances to step 3 where the variable display processing is performed. In this case, the image control circuit 71 is operated in accordance with the instruction from the main CPU 32 and game executing images including variable display images of the plurality of pseudo reels are displayed on the liquid crystal display panel 5. As a result, on the liquid crystal display panel 5, the plurality of pseudo reels are displayed in a variable mode laterally or horizontally at the center thereof thus displaying an activated payline which extends laterally at the center thereof (not shown in the drawing). Each pseudo reel includes a plurality of symbols and performs the variable display in a state that the respective symbols appear one after another in the irregular order.

Here, although not shown in the drawing, it may be possible that the main CPU 32 instructs the image control circuit 71 during the variable display processing such that the liquid crystal display panel 3 displays a three-dimensional image for an effect and the liquid crystal display panel 4 displays images for explaining the method for performing the game and the like.

After the processing in step 3 is finished, the flow advances to step 4 where the stop control processing is performed. Here, the respective pseudo reels in a scrolling state are stopped such that the respective pseudo reels correspond to a result of the lottery processing in step 2.

Next, the flow advances to step 5 where the main CPU 32 is operated as win approval/disapproval determination means and refers to a win determination table (symbol patterns which win the win and symbol patterns which do not win the win (non-winnings) being registered in a distinguishable manner in association with the combination of respective code No (hereinafter also referred to as “code No pattern”)) not shown in the drawing which is stored in the ROM 34, and determines the win approval/disapproval of the game using the code No patterns. In the above-mentioned step, the code No pattern corresponding to the stop position of the reel is determined and hence, the win determination table is referred in a state that the code No pattern is set in the search key and the win approval/disapproval is determined based on the result of reference. Here, when it is determined that the win is approved, the flow advances to step 6, while when it is determined that the win is disapproved, the main processing is finished without executing processing in steps 6 to 8.

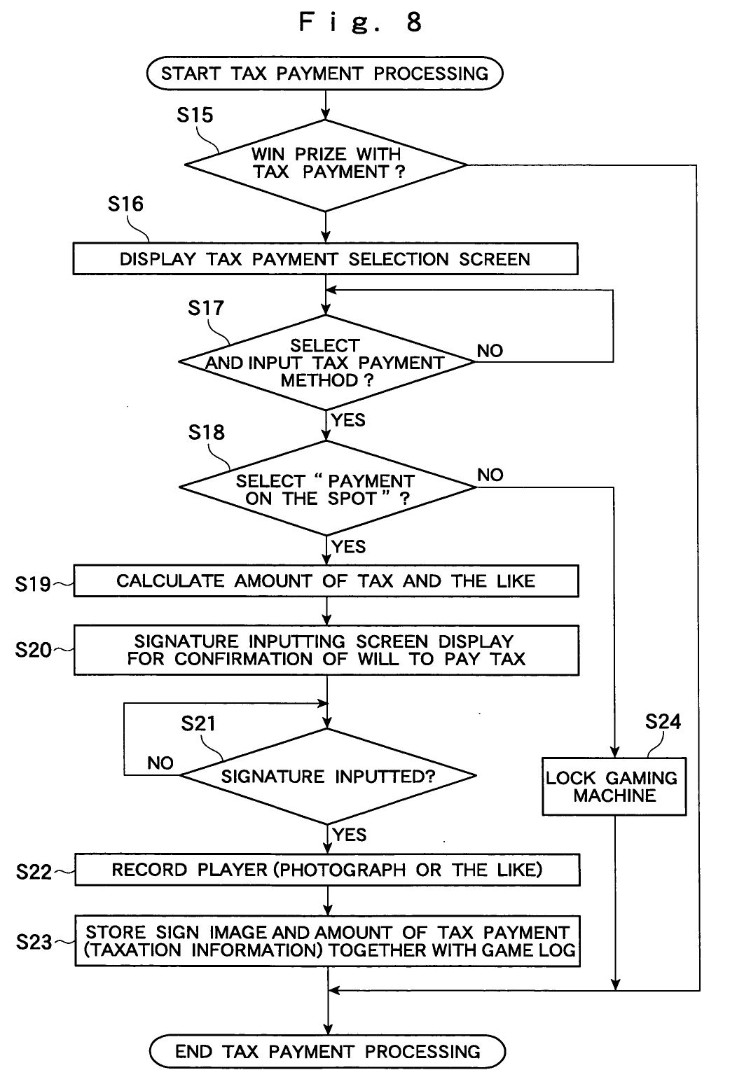

When the flow advances to step 6, the tax payment processing is started. This tax payment processing is performed in accordance with a flowchart shown in FIG. 8.

When the tax payment processing is started, in step 15, the main CPU 32 is operated as tax payment requirement determination means and determines the necessity of tax payment with respect to the win determined by step 5. That is, the main CPU 32 determines whether the win determined by step 5 is the big win and corresponds to the win which becomes the subject of taxation which requires tax payment (hereinafter referred to as “taxation win”) or not. Here, when the win corresponds to the taxation win, the flow advances to step 16 and, while when the win does not correspond to the win which requires tax payment, the tax payment processing is completed and returns to FIG. 6 and advances to step 7. In this embodiment whether the win corresponds to the taxation win or not is determined based on whether a payout ratio obtained from the payout table and the award (paid out amount of money) which is determined corresponding to coins which are supplied for BET are equal to or more than fixed values (for example, whether award is 1200 dollars or more when the place where the slot machine 1 is installed is Las Vegas of the State of Nevada, the United States). However, it is needless to say that the present invention is not limited to such conditions.

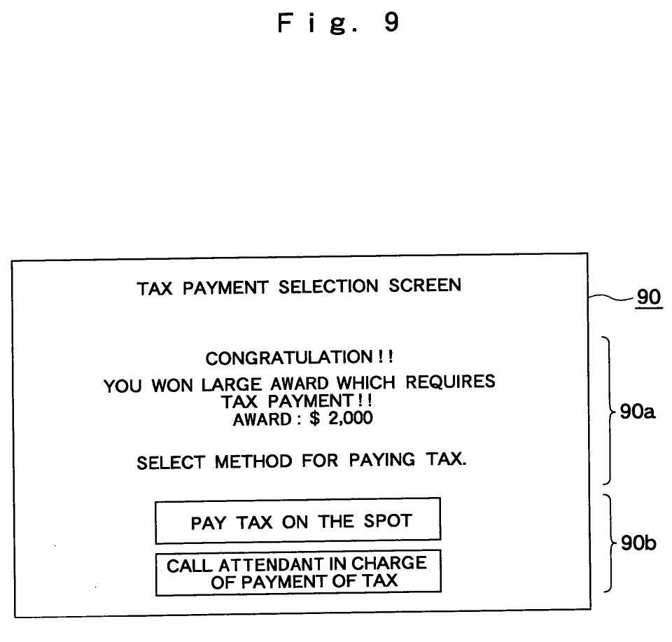

Subsequently, when the flow advances to step 16, the liquid crystal display panel 5 is operated as selection means in accordance with the instruction of the main CPU 32 and displays a tax payment selection screen 90. Here, the tax payment selection screen 90 is displayed in a layout shown in FIG. 9, for example. The tax payment selection screen 90 includes a display area 90a of a message that the player wins the win which requires tax payment and a display area 90b which displays the tax payment method. The player who obtains the win which requires tax payment (hereinafter referred to as “win player”) selects one of tax payment methods displayed on the display area 90b (here, “tax payment on the spot” and “tax payment by calling an attendant”) by reference to the tax payment selection screen 90 and touches the selected tax payment method with a finger. As a result, information which designates the tax payment method (tax payment method designation information) which the win player desires is inputted to the slot machine 1 from the touch panel 56. The win player can select the tax payment method which suits him/her using this tax payment selection screen 90.

Upon inputting of the tax payment method designation information from the touch panel 56 to the main CPU 32, the flow advances to step 18 from step 17. In step 18, the main CPU 32 determines whether the win player selects “tax payment on the spot” as the tax payment method or not based on the tax payment designation information. When it is determined that the “tax payment on the spot” is selected, the flow advances to step 19, while “tax payment on the spot” is not selected, the flow advances to step 24. As will be explained later, when “tax payment on the spot” is selected, the slot machine 1 performs withholding tax to obtain the award after tax described later.

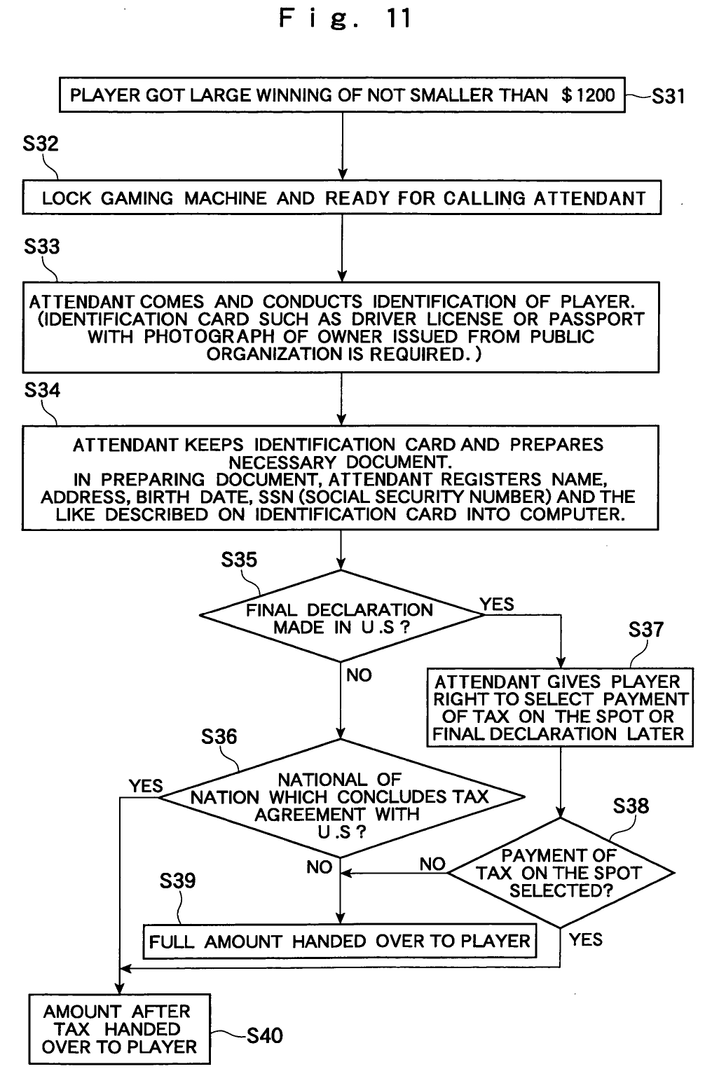

When the flow advances to step 24, the slot machine 1 assumes a so-called lock state in which the performance of the game is interrupted and hence, the performance operation of the game is interrupted. Thereafter, the flow advances to step 7 in FIG. 6 and the main processing is finished without executing the payout processing in next step 8. In this case, the player performs tax payment manually in the same manner as the prior art in accordance with the tax payment steps shown in FIG. 11 without using the withholding taxation by the slot machine 1.

On the other hand, when the flow advances to step 19, the main CPU 32 is operated as withholding tax means and calculates the tax amount to be paid and the like. Here, the main CPU 32, based on the award corresponding to the win which requires tax payment which the win player acquires, obtains a tax amount to be paid by multiplying the award with a predetermined tax rate and, further, performs the calculation processing to deduct the obtained tax amount from the award thus eventually obtaining the award after tax.

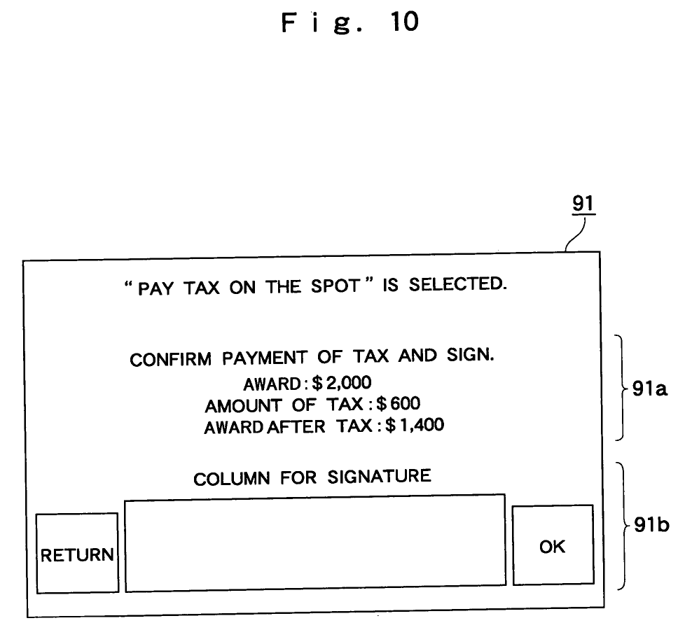

In the succeeding step 20, the liquid crystal display panel 5 is operated as the tax payment will inputting means in accordance with the instruction from the main CPU 32 and displays the tax payment confirmation screen 91. At this point of time, the tax payment confirmation screen 91 is displayed with a layout shown in FIG. 10, for example. The tax payment confirmation screen 91 includes a display area 91a of a message which requests the confirmation of tax payment will to perform tax payment based on the withholding tax which the slot machine 1 deducts the tax amount from the award (hereinafter also referred to as “automatic tax payment”) and a signature inputting part 91b.

In displaying the tax payment confirmation screen 91, the main CPU 32 allows the display area 91a to display the award, and the tax amount and the award after tax which are obtained in step 19. Here, in FIG. 10, in the display area 91a, the award: $2000, the tax amount: $600, the award after tax: $1400 are displayed.

The win player refers to the tax payment confirmation screen 91 and confirms the content of the award, the tax amount and the award after tax. When the win player has a will to pay tax in accordance with the automatic tax payment, the win player directly fills out his/her signature in a signature column of the signature inputting part 91b and touches an “OK” column of the signature inputting part 91b with his/her finger. Then, an image generation part 56a which is incorporated in a touch panel 56 generates image data of the filled-out signature (signature image data). By displaying the tax payment confirmation screen 91, prior to the automatic tax payment, the win player can confirm the content of the award, the tax amount and the award after tax in advance and can input the will to pay tax (wish to pay the tax) in accordance with the automatic tax payment to the slot machine 1. Here, in place of requesting the win player to fill out his/her signature in the signature column in the above-mentioned manner, it may be possible to request the win player to input a finger print of an index finger, a thumb or the like to the slot machine 1.

Then, in step 21, the operation stands by until the win player fills out the signature and the flow advances to step 22 upon inputting of the signature, and the player performs the recording processing. Here, in accordance with an instruction from the main CPU 32, the CCD camera 83 is operated as player information generation means and generates the player's information for recording the player. Here, the CCD camera 83 photographs a portion which can identify the win player (for example, player's face) and generates player's information from the image data of the photographed portion. Further, the CCD camera 83 stores the generated player's information in the auxiliary storage part 81. By generating and storing the player's information in this manner, it is possible to have the information for recording the player who performs the automatic tax payment. This information can be used as the recording of the player who performs the automatic tax payment.

Next, the flow advances to step 23 where the main CPU 32 generates the taxation information “In” which contains the player's information generated by step 22, the signature image data generated by step 20, and the award information, the tax amount information and the award-after-tax information respectively indicative of the award, the tax amount and the award after tax, and stores and preserves the taxation information “In” in the auxiliary storage part 81 together with the game log indicative of the performance conditions of the game. The taxation information “In” which is stored in the auxiliary storage part 81 is read out and outputted by the writing device 82 and is stored in the storage medium 82a when necessary. Further, in accordance with the instruction from the main CPU, the taxation information “In” is read out from the auxiliary storage part 81 every fixed period and this taxation information “In” is transmitted to the gaming server 100 via the network N by the communication processing part 42 which is operated in accordance with the instruction of the communication control part 41. In this manner, it is possible to output the taxation information “In” outside the slot machine 1 and hence, it is also possible to allow a gaming arena to perform the tax payment procedure to a tax payment authority using the taxation information. Here, the taxation information “In” may be outputted in a state that the taxation information “In” is directly transmitted to the gaming server 100 in real time each time the taxation information “In” is generated without storing the taxation information “In” in the auxiliary storage part 81.

When the processing in step S24 and the processing in step S24 are executed, the tax payment processing is finished. Then, the flow advances to step 7 of the main processing shown in FIG. 6 and it is determined whether the gaming machine is in a locked state or not. Here, when the gaming machine is not in a locked state, the flow advances to step 8, while when the gaming machine is in a locked state, the processing is finished without being executed in step S8. When the flow advances to step 8 and the payout processing is performed, the main CPU 32 instructs the hopper drive circuit 63 to pay out the number of coins which corresponds to the award after tax and the coins are paid out from the hopper 64. Further, when the main CPU 32 determines that the number of coins which corresponds to the award after tax is paid out in response to a signal from the payout completion signal circuit 65, the payout processing is finished and, eventually with the above-mentioned processing, the main processing is finished. (In this case, a ticket with a bar code which records the number of coins to be paid out may be outputted from a ticket printer not shown in the drawing.)

On the other hand, when the flow advances to step 24 and the gaming machine is locked, this shows a case that the win player selects the “Call an attendant and pay tax” in step 18. In this case, the slot machine 1 performs tax payment manually (hereinafter referred to as “manual tax payment”) in accordance with the conventional procedure without using the above-mentioned award after tax. This manual tax payment is performed in order of steps shown in FIG. 11, for example. FIG. 11 shows one example of the tax payment steps in accordance with manual tax payment, wherein the tax payment steps which are performed in the State of Nevada, the United States. are illustrated here.

First of all, as shown in step 31, assume that the player gets the winnings of not smaller than $1200 (big winnings) and the win which requires tax payment is generated. Then, in the succeeding step 32, the slot machine 1 is locked so as to bring a state in which an attendant of a playing arena is called (Here, this state corresponds to the above-mentioned step 24). Next, as described in step 33, the attendant comes to an installation place of the corresponding slot machine 1 which produces the win which requires tax payment and performs the identification of the win player. Here, the identification of the player is performed using an identification card with a picture of the win player which is issued by a public organization (for example, a driver's license or a passport). Then, the flow advances to step 34 where the attendant keeps the identification card submitted in step 33 and the attendant prepares a document necessary for the tax payment procedure by reference to the identification card. In preparing the document, the name, the address, a birth date, SSN (social security number) and the like of the identification card are registered in a computer (not shown in the drawing).

Next, as shown in step 35, the processing differs depending on whether the win player performs the final declaration in the United States or not. If the win player performs the final declaration in the United States, the flow advances to step 37, while if the win player does not perform the final declaration in the United States, the flow advances to step 36. When the flow advances to step 36, the processing differs depending on whether the win player is a national of a country which concludes a taxation agreement with the United States or not. When the win player is a national of such a country, the flow advances to step 40, while when win player is not a national of such a country, the flow advances to step 39. In step 37, the win player selects one of tax payment which pays the tax on the spot (hereinafter referred to “tax payment on the spot”) and tax payment which pays the tax later (hereinafter referred to as “post tax payment”). With respect to the selection of one of these payments by the win player, as described in succeeding step 38, when the win player selects tax payment on the spot, the flow advances to step 40, while when the win player selects the post tax payment, the flow advances to step 39. In step 39, a total amount of award is handed over to the win player from the attendant (so-called “hand-pay”). In step 40, an amount which is obtained by deducting the amount of tax from the award is paid out to the win player from the attendant by the hand-pay.

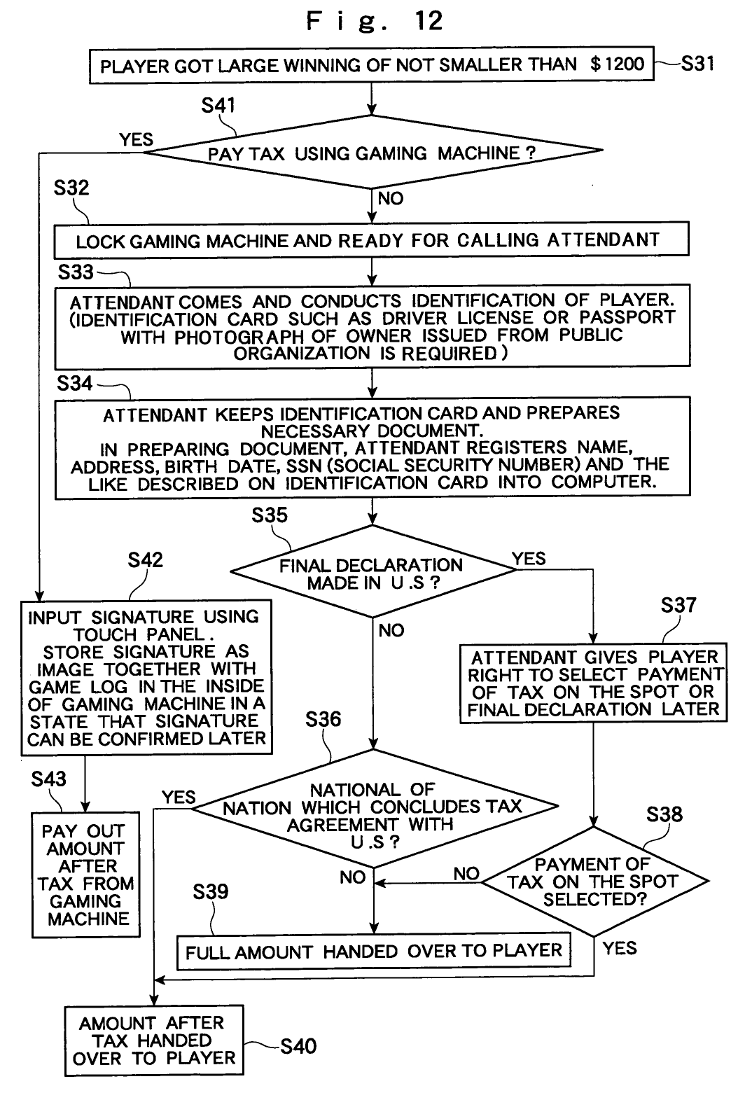

Further, in this embodiment, due to the provision of the slot machine 1, the automatic tax payment is provided in addition to the tax payment steps in accordance with the manual tax payment and hence, tax payment is performed in accordance with steps shown in FIG. 12. That is, following step 31, the flow advances to step 41 and the subsequent processing differs depending on whether the win player pays tax using the gaming machine or not (the automatic tax payment based on withholding tax which the gaming machine performs or the manual tax payment which does not use the withholding tax) (this step corresponding to the above-mentioned step 18). If tax payment adopts the former, the flow advances to step 42. On the other hand, if tax payment adopts the latter, the flow advances to step 32 and tax payment is processed thereafter in the same manner as steps shown in FIG. 11. When the flow advances to step 42, the win player performs the inputting of signature on a touch panel (the step corresponding to the above-mentioned step 20), and in step 43, an amount of money corresponding to the award after tax is paid out (the step corresponding to the above-mentioned step 8).

On the other hand, in the gaming server 100, the CPU 101 is operated in accordance with the control program stored in the ROM 102 and instructs the communication control part 105 to operate the communication processing part 106 and receives the taxation information “In” transmitted from the slot machine 1 via the network N. Further, the CPU 101 is operated as tax amount calculation means and adds up the tax amount information contained in the taxation information “In” with a predetermined unit (for example, every specific period such as one week, one month) so as to calculate the sum of the tax that a gaming arena where the slot machine 1 is installed has to pay (total tax payment amount). The calculated total tax payment amount is stored in the hard disc drive 104 and is used when the gaming arena performs the tax payment processing to the tax payment bureau when necessary.

As described above, according to this embodiment, in the slot machine 1, when the win which requires tax payment is generated, the slot machine 1 acquires the award after tax which is obtained by deducting the tax amount to be paid from the award, and the payout corresponding to the award after tax can be performed. Conventionally, when the win which requires tax payment is generated, the player has to wait for the payout for a long time due to the preparation of documents necessary for tax payment. According to this embodiment, such a drawback can be made extremely small and hence, the slot machine 1 can continuously sustain the gaming interest imparted to the player without damaging the joy, the excitement and the like which are obtained by acquiring the big win.

Further, the conventional gaming machine is cumbersome with respect to a point that the player has to perform the procedures such as filling out his/her signature in necessary documents and the like after the attendant of the gaming arena arrives. On the other hand, the attendant of the gaming arena also feels cumbersomeness since the attendant has to prepare necessary documents and has to hand over the payout of the amount of money after the tax is deducted. To the contrary, according to the slot machine 1 of this embodiment, when the player wins the win which requires tax payment, the slot machine 1 automatically obtains the award after tax and performs the payout after the tax amount is deducted in advance before the payout (in accordance with the award after tax) and hence, tax payment is finished as if the win player performs tax payment by himself/herself. Accordingly, it is no more necessary for the win player to wait for the payment of the award only for the sake of tax payment before the win player receives the award and, at the same time, it is no more necessary for the win player to perform the cumbersome procedure such as filling out his/her signature in the necessary documents. Still further, the attendant of the gaming arena is also released from the cumbersomeness that the attendant has to hand over the award after deducting the tax amount. In this manner, the procedures necessary for tax payment is simplified for both of the win player and the attendant of the gaming arena.

On the other hand, in performing the above-mentioned automatic tax payment, the slot machine 1 allows the player to select the tax payment method and performs the automatic tax payment only when the player expresses his/her will of paying tax in accordance with the automatic tax payment by replying the selection request. Accordingly, there is no case that the slot machine 1 deducts the tax amount against the will of the player. Further, the player can confirm in advance the tax amount that the player has to pay by himself/herself and the award that the player can receive prior to tax payment and hence, the player is released from the fear that the taxis deducted by the slot machine 1 without the player's permission.

(Modification of Content of Operation of Gaming System)

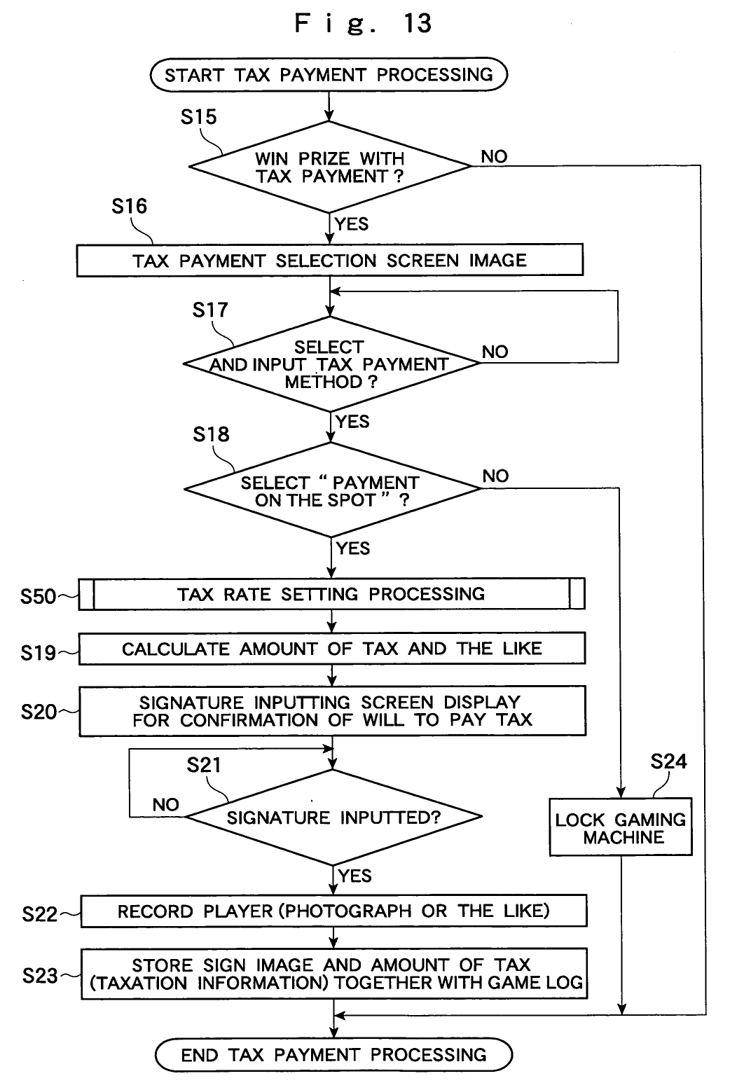

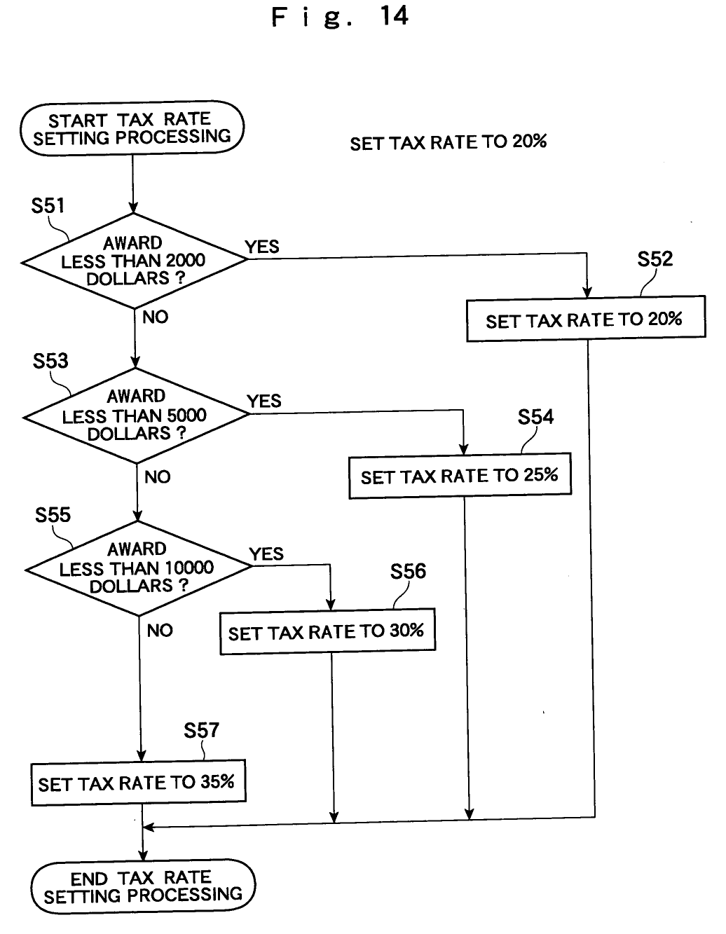

Next, the gaming system according to a modification of this embodiment is explained in conjunction with FIG. 13 and FIG. 14.

In the above-mentioned embodiment, the tax amount to be paid is obtained by multiplying the award with the predetermined tax rate, wherein it is assumed that the tax rate is set equal irrespective of the award. On the other hand, in the gaming system 300 of this embodiment, the slot machine 1 sets the tax rate corresponding to the award and the tax amount to be paid is obtained using the set tax rate (using the same server 100). Hereinafter, the explanation is made by focusing on points which make the gaming system 300 of this modification different from the gaming system 300 of the above-mentioned embodiment and points which are common between the embodiment and the modification are omitted or simplified.

In the gaming system 300 of this embodiment, in the content of the operation of the slot machine 1, the processing up to the determination whether “tax payment on the spot” is selected or not in step 18 is equal to the processing of the slot machine 1 according to the above-mentioned embodiment.

Then, when it is determined that “tax payment on the spot” is selected in step 18, the flow advances to step 50 where the main CPU 32 is operated as tax rate setting means and the tax rate setting processing is started. This tax rate setting processing is performed in accordance with a flow chart shown in FIG. 14.

When the tax rate setting processing is started, the main CPU 32 determines whether the award corresponding to the win which requires tax payment which the win player acquires is less than 2000 dollars or not in step 51. When the award is less than 2000 dollars, the flow advances to step 52, while when the award is not less than 2000 dollars, the flow advances to step 53. In step 53, the main CPU 32 determines whether the award is less than 5000 dollars or not. When the award is less than 5000 dollars, the flow advances to step 54, while when the award is not less than 5000 dollars, the flow advances to step 55. Further, in step 55, the main CPU 32 determines whether the award is less than 10000 dollars or not. When the award is less than 10000 dollars, the flow advances to step 56, while when the award is not less than 10000 dollars, the flow advances to step 57.

Then, in steps 52, 54, 56 and 57, the tax rates for obtaining the tax amounts are respectively set to 20%, 25%, 30% and 35%. In this manner, in the tax rate setting processing, the tax rates are set in accordance with the progressive taxation method which gradually increases the tax rate corresponding to the increase of the award that the win player acquires. By performing this tax rate setting processing, for example, when the award is 1500 dollars, it is determined that the award is less than 2000 dollars in step 51 and the tax rate of 20% is set in step 52.

Subsequently, when the flow advances to step 19, the main CPU is operated as the withholding tax means and calculates the tax amount to be paid or the like using the tax rate set in step 50. That is, the award after tax is obtained by the calculation processing in such a manner that the tax amount to be paid is obtained by multiplying the award which the win player acquires with the tax rate set in step 50 and, thereafter, the obtained tax amount is deduced from the award. For example, when the award is 1500 dollars in the same manner as the above-mentioned example, the tax amount is calculated as 300 dollars due to tax rate set to 20% and this tax amount is deducted from the award and 1200 dollars which is the award after tax is obtained. Then, this 1200 dollars are paid out to the win player.

Since the processing in steps which follow step 20 are equal to those of the slot machine 1 according to the above-mentioned embodiment, the explanation thereof is omitted.

As described above, according to the slot machine 1 of this embodiment, the tax rates are calculated in accordance with the progressive taxation method which gradually increases the tax rates corresponding to the increase of the award which the win player acquires. Accordingly, the higher the award which the win player acquires, the tax amount that the win player has to pay is increased and hence, it is possible to alleviate the tax amount that the low-amount-award player has to pay compared to the tax amount that the high-amount-award player has to pay.

Further, in this embodiment, the tax rates are respectively classified corresponding to cases in which the awards which the win player acquires are 2000 dollars, 5000 dollars and 10000 dollars respectively. However, the tax rates may be classified in accordance with awards of amounts which differ from the above-mentioned amounts.

Further, in this embodiment, the tax rates are gradually increased in order of 20%, 25%, 30% and 35% corresponding to the increase of the amount of the award. However, the tax rates are not limited to the above and may be set to proper tax rates corresponding to the place where the slot machine 1 is installed.

Further, to prevent the tax amount to be paid of the player who acquires the award of high tax rate from becoming excessively high, the tax amounts may be summed for each player and the amount of tax to be paid may be adjusted for each player. Still further, it may be possible that when the total amount of tax payment becomes short, the gaming arena pays an amount corresponding to the shortage.

Here, although the explanation has been made with respect to the example in which the slot machine is taken as the gaming machine, the present invention is not limited to the slot machine and is applicable to other gaming machine which pays out awards corresponding to contents of wins of games such as a card gaming machine. In case of the card gaming machine, the win approval/disapproval is determined by whether the combination of cards agree with a predetermined “yaku (winning combination)” or not, for example. In case of other gaming machine (for example, a roulette gaming machine), the win approval/disapproval is determined based on a position where a ball is stopped and a position which a player bets.

### Embodiment 2

The system constitution of a gaming system, the entire constitution of a slot machine and the constitution of a gaming server according to the second embodiment are equal to those of the first embodiment and the embodiment 2 differs from the embodiment 1 with respect to an operational content of the gaming system.

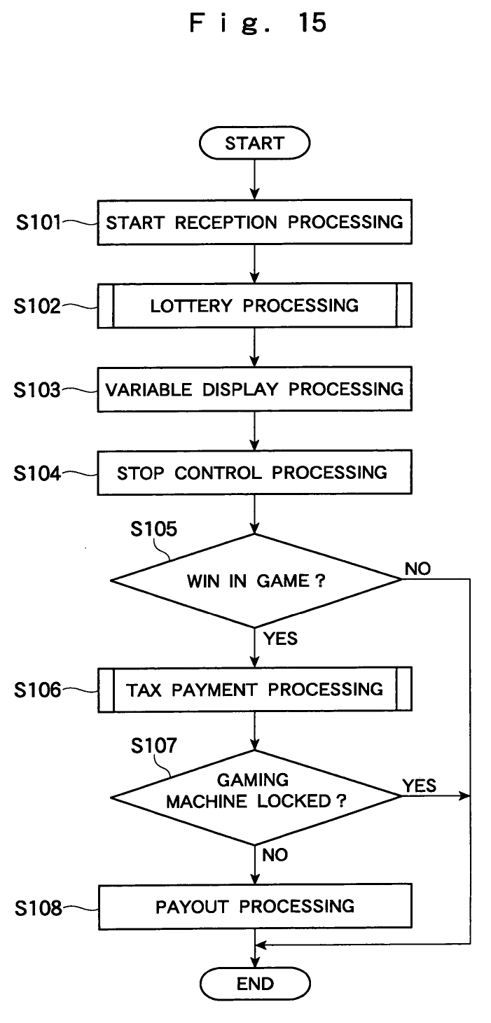

Hereinafter, the operational content of the gaming system 300 according to the embodiment 2 is explained in conjunction with flow charts shown in FIG. 15 to FIG. 17.

(Operational Content of the Gaming System According to Embodiment 2)

FIG. 15 is a flow chart showing the operational steps of the main processing from a start to an end of a game in the slot machine 1. Here, in FIG. 15 to FIG. 17, the steps are abbreviated as “S”.

As shown in FIG. 15, when the slot machine 1 starts the main processing, at the time of starting the game, the start reception processing is performed in step 101 and the lottery processing is performed in the succeeding step 102.

Firstly, when the flow advances to the start reception processing in step 101, the slot machine 1 receives an operation for starting the game from the player in accordance with the control from the main CPU 32. The player starts the game. To start the pseudo reels (to allow the pseudo reels to perform variable display), first of all, the player inserts the number of coins which the player bets in one game into the coin insertion slot 6, sets the number of coins which the player bets in one game by controlling BET selection button 9 and, further, sets the activated payline by controlling the line selection button 100. Subsequently, spin button 8 is controlled (this control being referred to as “start control” hereinafter). Due to this start control, the start signal is inputted to the main CPU 32 from the start switch 51 (in case of the credit, the BET selection signal is inputted from the BET switch 52).

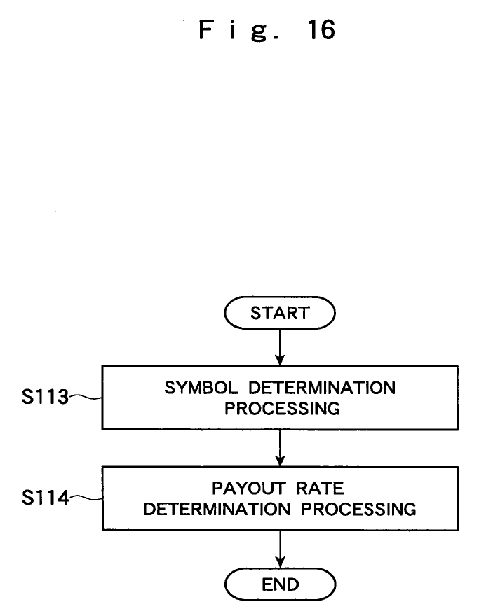

Next, the flow advances to step 102 and the lottery processing is performed. When the lottery processing is started, the flow advances to step 113 shown in FIG. 16 and the symbol determination processing is performed by the main CPU 32. In this symbol determination processing, the main CPU 32 determines the symbols which are stopped at the set activated payline for respective pseudo reels.

Then, in the lottery processing, when the main CPU 32 detects the start control of the player in response to an input signal from the start switch 51, instructs the random number generator 35 to generate the random numbers within a fixed range upon receiving the detection (that is, with this game start as an opportunity). Further, the main CPU 32 instructs the sampling circuit 36 to sample arbitrary random numbers output of the random numbers generated by the random number generator 35. When the random numbers are sampled, the main CPU 32 sets the random numbers in a search key and refers to a symbol determination table (a table which stores code No of symbols and the random numbers in an associated manner) not shown in the drawing which is stored in the ROM 34, and acquires the code numbers of the corresponding symbols.

Next, the acquired code numbers are set in the search key and a stop table (a table which stores the code No of symbols and the symbols in an associated manner) not shown in the drawing is referred and the corresponding symbols are retrieved with respect to respective pseudo reels.

Then, in the slot machine 1, the above-mentioned sampling of random numbers and the search of the symbol determination table and stop table are performed for the respective pseudo reels. Further, when the symbols are determined with respect to the respective pseudo reels, the reel stop positions for stopping the symbols on the activated payline are determined.

Further, the main CPU 32 advances to step 114 and refers to a payout table not shown in the drawing, and determines a magnification of payout (a payout ratio) corresponding to a symbol pattern. Here, the payout ratio per one coin corresponding to each symbol pattern is registered to the payout table. Due to the above-mentioned operation, the lottery processing is finished.

Next, the flow advances to step 103 where the variable display processing is performed. In this case, the image control circuit 71 is operated in accordance with the instruction from the main CPU 32 and game executing images including variable display images of the plurality of pseudo reels are displayed on the liquid crystal display panel 5. As a result, on the liquid crystal display panel 5, the plurality of pseudo reels are displayed in a variable mode laterally or horizontally at the center thereof thus displaying a linear activated payline which extends laterally at the center thereof (not shown in the drawing). Each pseudo reel includes a plurality of symbols and performs the variable display in a state that the respective symbols appear one after another in the irregular order.

Here, although not shown in the drawing, it may be possible that the main CPU 32 instructs the image control circuit 71 during the variable display processing such that the liquid crystal display panel 3 displays a three-dimensional image for a game effect and the liquid crystal display panel 4 displays images for explaining the method for performing the game and the like.

After the processing in step 103 is finished, the flow advances to step 104 where the stop control processing is performed. Here, the respective pseudo reels in a scrolling state are stopped such that the respective pseudo reels correspond to a result of the lottery processing in step 102.

Next, the flow advances to step 105 where the main CPU 32 is operated as win approval/disapproval determination means and refers to a win determination table (symbol patterns which win the win and symbol patterns which do not win the win (non-winnings) being registered in a distinguishable manner in association with the combination of respective code No (hereinafter also referred to as “code No pattern”)) not shown in the drawing which is stored in the ROM 34, and determines the win approval/disapproval of the game. In the above-mentioned step, the code No pattern corresponding to the stop position of the reel is determined and hence, the win determination table is referred in a state that the code No pattern is set in the search key and the win approval/disapproval is determined based on the result of reference. Here, when it is determined that the win is approved, the flow advances to step 106, while when it is judged that the win is disapproved, the main processing is finished without executing processing in steps 106 to 108.

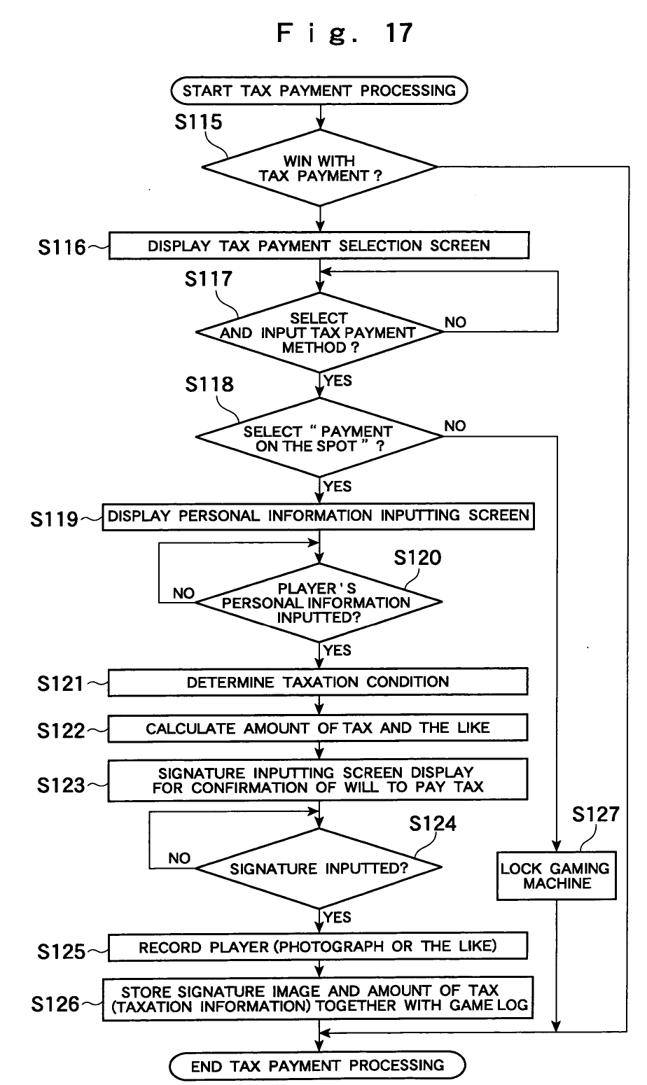

When the flow advances to step 106, the tax payment processing is started. This tax payment processing is performed in accordance with a flowchart shown in FIG. 17.

When the tax payment processing is started, in step 115, the main CPU 32 is operated as tax payment requirement determination means and determines the necessity of tax payment with respect to the winnings determined by step 105. That is, the main CPU 32 determines whether the win determined by step 105 is the big win and corresponds to the win which becomes the subject of taxation which requires tax payment (hereinafter referred to as “taxation win”) or not. Here, when the win corresponds to the taxation win, the flow advances to step 116 and, while when the win does not correspond to the taxation input, the tax payment processing is completed and returns to FIG. 15 and advances to step 107. In this embodiment, whether the win corresponds to the taxation win or not is determined based on whether a payout ratio obtained from the payout table and the award (paid out amount of money) which is determined corresponding to coins which are supplied for BET are equal to or more than fixed values (for example, whether award is 1200 dollars or more when the place where the slot machine 1 is installed is Las Vegas in Nevada State, US. However, it is needless to say that the present invention is not limited to such conditions.

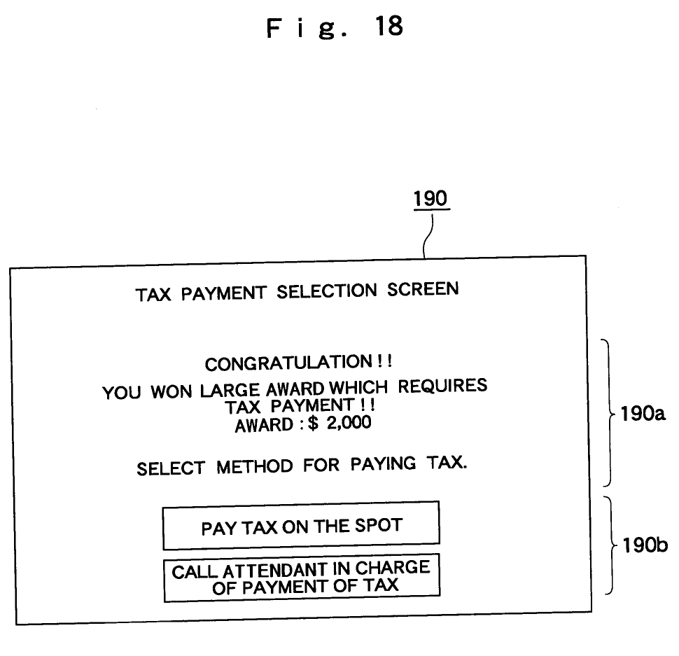

Subsequently, when the flow advances to step 116, the liquid crystal display panel 5 is operated as selection means in accordance with the instruction of the main CPU 32 and displays a tax payment selection screen 90. Here, the tax payment selection screen 90 is displayed in a layout shown in FIG. 18, for example. The tax payment selection screen 90 includes a display area 90a of a message that the player wins the win which requires tax payment and a display area 90b which displays the tax payment method. The player who obtains the win which requires tax payment (hereinafter referred to as “win player”) selects one of tax payment methods displayed on the display area 90b (here, “tax payment on the spot” and “tax payment by calling an attendant”) which are displayed on the display area 90b by reference to the tax payment selection screen 90 and touches the selected tax payment method with a finger. As a result, information which designates the tax payment method (tax payment method designation information) which the win player desires is inputted to the slot machine 1 from the touch panel 56. The win player can select the tax payment method which suits him/her using this tax payment selection screen 90.

Upon inputting of the tax payment method designation information from the touch panel 56 to the main CPU 32, the flow advances to step 118 from the step 117. In step 118, the main CPU 32 determines whether the win player selects “tax payment on the spot” as the tax payment method or not based on the tax payment designation information. When it is determined that the “tax payment on the spot” is selected, the flow advances to step 119, while “tax payment on the spot” is not selected, the flow advances to step 127. As will be explained later, when “tax payment on the spot” is selected, the slot machine 1 performs withholding tax to obtain the award after tax described later.

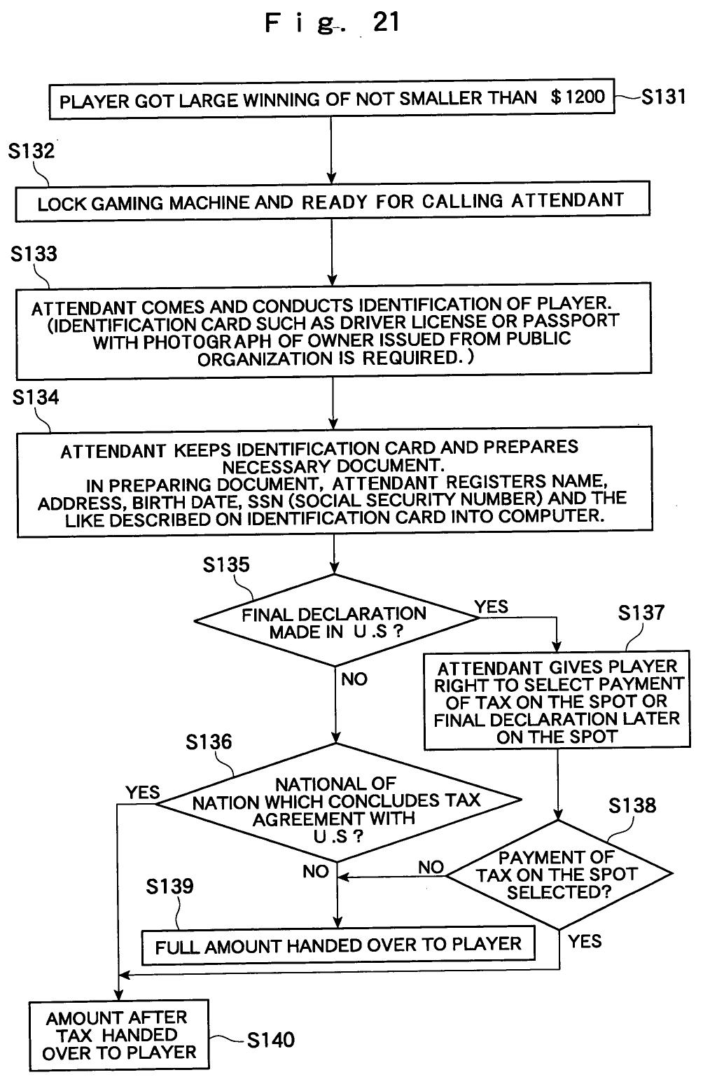

When the flow advances to step 127, the slot machine 1 assumes a so-called lock state in which the performance of the game is interrupted and hence, the performance operation of the game is interrupted. Thereafter, the flow advances to step 107 in FIG. 15 and the main processing is finished without executing the payout processing in the next step 108. In this case, the player performs tax payment manually in the same manner as the prior art in accordance with the tax payment steps shown in FIG. 21 without using the withholding taxation by the slot machine 1.

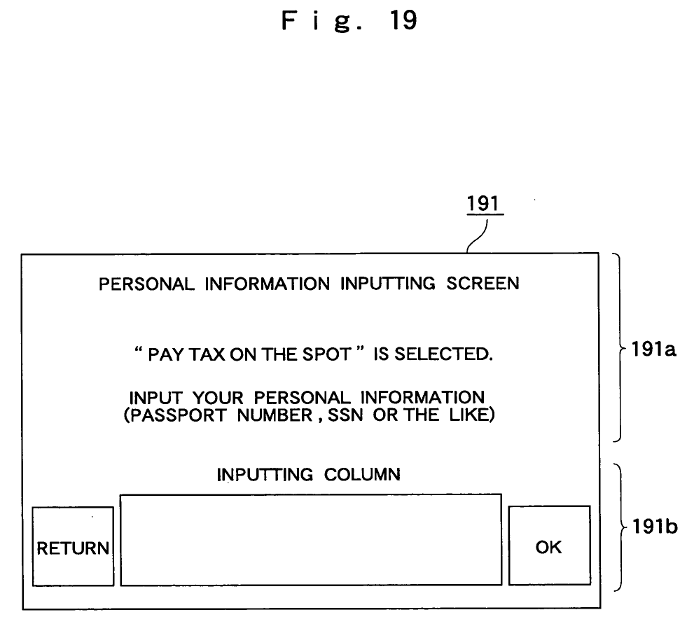

On the other hand, when the flow advances to step 119, the liquid crystal display panel 5 is operated as the personal information inputting means in accordance with an instruction from the main CPU 32 and displays the personal information inputting screen 191. Here, the personal information inputting screen 191 is displayed with a layout shown in FIG. 19, for example. This personal information inputting screen 191 includes a display area 191a for a message which requires the win player the inputting of personal information for identifying the individual player (for example, driver's license number, passport number, SSN (Social Security Number) or the like (hereinafter referred to as “player's personal information”) and an inputting part 191b of the personal information. The win player, upon confirmation of the message on the display area 191a, inputs the personal information to the input part 191b and touches an “OK” column of the inputting part 191b with his/her finger to complete the inputting of the player's personal information by the self-assessment. In the succeeding step 120, the slot machine 1 stands by until the inputting of the player's personal information using a touch panel 56, and the flow advances to step 121 when the inputting is confirmed.

In step 121, the main CPU 32 is operated as condition determination means and determines the taxation conditions based on the player's personal information inputted in step 119. Although described in detail later, there exist several conditions for determining the amount of tax imposed on the award and the tax payment method (for example, tax rates, withholding tax, self-assessment and the like, hereinafter referred to as “taxation conditions”), wherein the applicable taxation conditions can be determined in accordance with nationalities and ages of the tax payers and laws and regulations of countries and regions where the slot machines are installed. Accordingly, the slot machine 1 allows the inputting of the player's personal information in step 119 and the main CPU 32 determines the taxation conditions based on the player's personal information. Here, with respect to the United States, the tax payment method and the taxation conditions differ based on whether the player performs the final declaration in the United States and hence, the presence or non-presence of the final declaration is inputted to the personal information inputting screen 191.

Next, when the flow advances to step 122, the main CPU 32 is operated as withholding tax means and calculates the tax amount to be paid and the like. Here, the main CPU 32, based on the award corresponding to the win which requires tax payment which the win player acquires, obtains a tax amount to be paid by multiplying the award with a predetermined tax rate which corresponds to the taxation conditions determined in step 121 and, further, performs the calculation processing to deduct the obtained tax amount from the award thus eventually obtaining the award after tax.

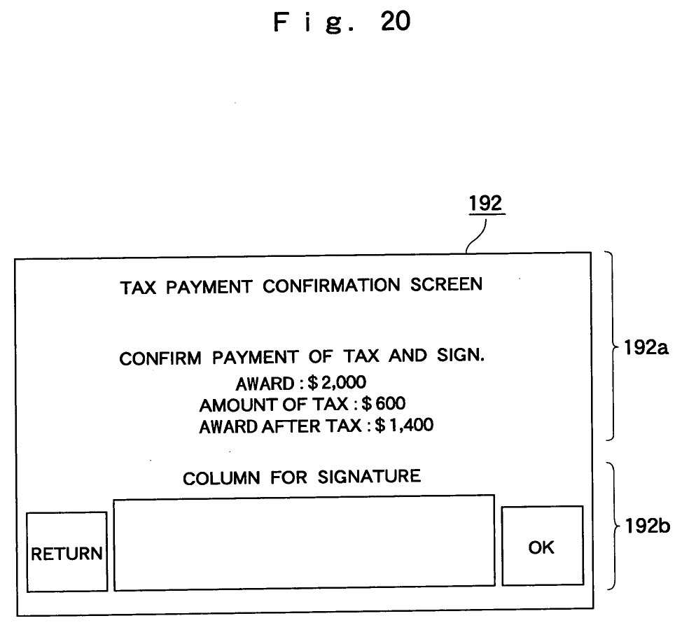

In the succeeding step 123, the liquid crystal display panel 5 is operated as the tax payment will inputting means in accordance with the instruction from the main CPU 32 and displays the tax payment confirmation screen 192. At this point of time, the tax payment confirmation screen 192 is displayed with a layout shown in FIG. 20, for example. The tax payment confirmation screen 192 includes a display area 192a of a message which requests the confirmation of the tax payment will to perform tax payment based on the withholding tax which the slot machine 1 deducts the tax amount from the award (hereinafter also referred to as “automatic tax payment”) and a signature inputting part 192b.

In displaying the tax payment confirmation screen 192, the main CPU 32 allows the display area 192a to display the award, and the tax amount and the award after tax which are obtained in step 122. Here, in FIG. 20, in the display area 192a, the award: $2000, the tax amount: $600, the award after tax: $1400 are displayed.

The win player refers to the tax payment confirmation screen 192 and confirms the content of the award, the tax amount and the award after tax. When the win player has a will to pay tax in accordance with the automatic tax payment, the win player directly fills out his/her signature in a signature column of the signature inputting part 192b and touches an “OK” column of the signature inputting part 192b with his/her finger. Then, an image generation part 56a which is incorporated in a touch panel 56 generates image data of the filled-out signature (signature image data). By displaying the tax payment confirmation screen 192, prior to the automatic tax payment, the win player can confirm the content of the award, the tax amount and the award after tax in advance and can input the will to pay tax (wish to pay the tax) in accordance with the automatic tax payment to the slot machine 1. Here, in place of requesting the win player to fill out his/her signature in the signature column in the above-mentioned manner, it may be possible to request the win player to input a finger print of an index finger, a thumb or the like to the slot machine 1.

Then, in step 124, the operation stands by until the win player fills out the signature and the flow advances to step 125 upon inputting of the signature, and the player performs the recording processing. Here, in accordance with an instruction from the main CPU 32, the CCD camera 83 is operated as player information generation means and generates the player's information for recording the player. Here, the CCD camera 83 photographs a portion which can identify the win player (for example, player's face) and generates player's information from the image data of the photographed portion. Further, the CCD camera 83 stores the generated player's information in the auxiliary storage part 81. By generating and storing the player's information in this manner, it is possible to have the information for recording the player who performs the automatic tax payment. This information can be used as the recording of the player who performs the automatic tax payment.

Next, the flow advances to step 126 where the main CPU 32 generates the taxation information “In” which contains the player's information generated by step 125, the signature image data generated by step 123, and the award information, the tax amount information and the award-after-tax information respectively indicative of the award, the tax amount and the award after tax obtained by step 122, and stores and preserves the taxation information “In” in the auxiliary storage part 81 together with the game log indicative of the performance condition of the game. The taxation information “In” which is stored in the auxiliary storage part 81 is read out and outputted by the writing device 82 and is stored in the storage medium 82a when necessary. Further, in accordance with the instruction from the main CPU 32, the taxation information “In” is read out from the auxiliary storage part 81 every fixed period and this taxation information “In” is transmitted to the gaming server 100 via the network N by the communication processing part 42 which is operated in accordance with the instruction of the communication control part 41. In this manner, it is possible to output the taxation information “In” outside the slot machine 1 and hence, it is possible to allow a gaming arena to perform the tax payment procedure to a tax payment authority using the taxation information. Here, the taxation information “In” may be outputted in a state that the taxation information “In” is directly transmitted to the gaming server 100 in real time each time the taxation information “In” is generated without storing the taxation information “In” in the auxiliary storage part 81.

When the processing in step S126 and the processing in step S127 are executed, the tax payment processing is finished. Then, the flow advances to step 107 of the main processing shown in FIG. 15 and it is determined whether the gaming machine is in a locked state or not. Here, when the gaming machine is not in a locked state, the flow advances to step 108, while when the gaming machine is in a locked state, the processing is finished without being executed in step 108. When the flow advances to step 108 and the payout processing is performed, the main CPU 32 instructs the hopper drive circuit 63 to pay out the number of coins which corresponds to the award after tax and the coins are paid out from the hopper 64. Further, when the main CPU 32 determines that the number of coins which corresponds to the award after tax is paid out in response to a signal from the payout completion signal circuit 65, the payout processing is finished and, eventually with the above-mentioned processing, the main processing is finished. (In this case, a ticket with a bar code which records the number of coins to be paid out may be outputted from a ticket printer not shown in the drawing.)

On the other hand, when the flow advances to step 127 and the gaming machine is locked, this shows a case that the win player selects the “Call an attendant and pay tax” in step 118. In this case, the slot machine 1 performs tax payment manually (hereinafter referred to as “manual tax payment”) in accordance with the conventional procedure without using the above-mentioned award after tax. This manual tax payment is performed in order of steps shown in FIG. 21, for example. FIG. 21 shows one example of the tax payment steps in accordance with manual tax payment, wherein the tax payment steps performed in State of Nevada are illustrated.

First of all, as shown in step 131, assume that the player gets the winnings of not smaller than $1200 (big winnings) and the win which requires tax payment is generated. Then, in the succeeding step 132, the slot machine 1 is locked so as to bring a state in which an attendant of a playing arena is called (here, this state corresponds to the above-mentioned step 124). Next, in step 133, the attendant comes to an installation place of the corresponding slot machine 1 which produces the win which requires tax payment and performs the identification of the win player. Here, the identification of the player is performed using an identification card with a picture of the win player which is issued by a public organization (for example, a driver's license or a passport). Then, the flow advances to step 134 where the attendant keeps the identification card submitted in step 133 and the attendant prepares a document necessary for the tax payment procedure by reference to the identification card. In preparing the document, the name, the address, a birth date, SSN (social security number) and the like of the identification card are registered in a computer (not shown in the drawing).

Next, as shown in step 135, the processing differs depending on whether the win player performs the final declaration in the United States or not. If the win player performs the final declaration in the United States, the flow advances to step 137, while if the win player does not perform the final declaration in the United States, the flow advances to step 136. When the flow advances to step 136, the processing differs depending on whether the win player is a national of a country which concludes a taxation agreement with the United States. When the win player is a national of such a country, the flow advances to step 140, while when win player is not a national of such a country, the flow advances to step 139. In step 137, the win player selects one of tax payment which pays the tax on the spot (hereinafter referred to “tax payment on the spot”) and tax payment which pays the tax later (hereinafter referred to as “post tax payment”). With respect to the selection of one of these payments by the win player, as described in succeeding step 138, when the win player selects tax payment on the spot, the flow advances to step 140, while when the win player selects the post tax payment, the flow advances to step 139. In step 139, a total amount of award is handed over to the win player from the attendant (so-called “hand-pay”). In step 140, an amount which is obtained by deducting the amount of tax from the award is paid out to the win player from the attendant by the hand-pay.

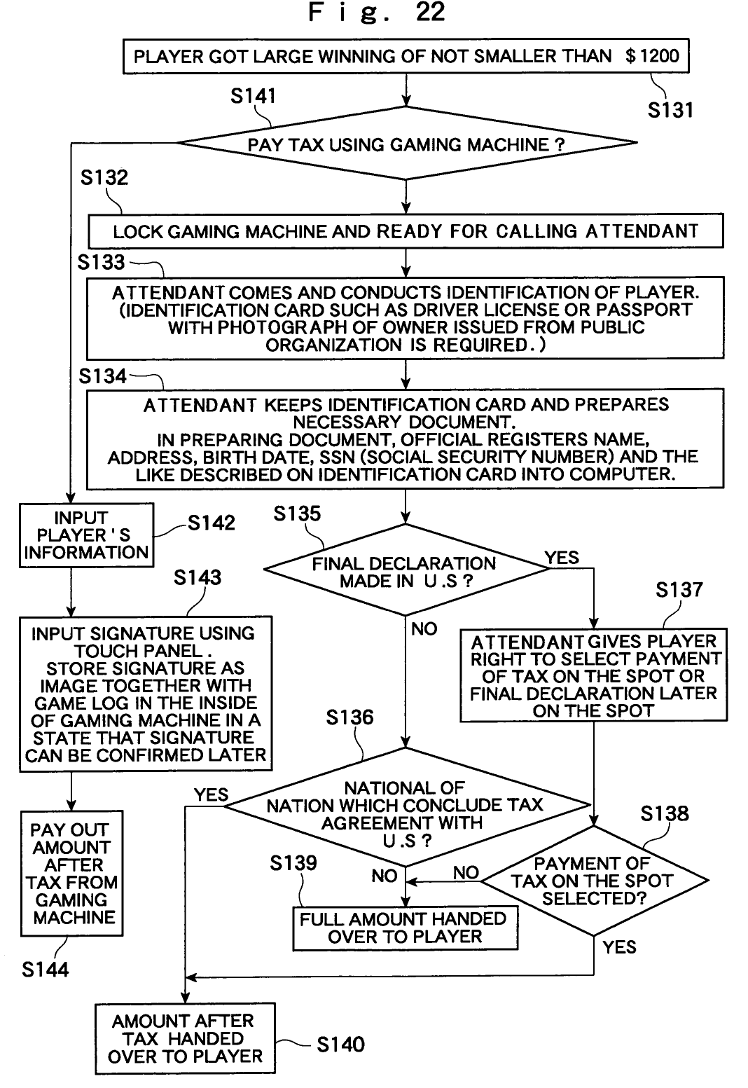

Further, in this embodiment, due to the provision of the slot machine 1, the automatic tax payment is provided in addition to the tax payment steps in accordance with the manual tax payment and hence, tax payment is performed in accordance with steps shown in FIG. 22. That is, following step 131, the flow advances to step 141 and the subsequent processing differs depending on whether the win player pays tax using the gaming machine or not (the automatic tax payment based on withholding tax which the gaming machine performs or the manual tax payment which does not use the withholding tax) (this step corresponding to the above-mentioned step 118). If tax payment adopts the former, the flow advances to step 142. On the other hand, if tax payment adopts the latter, the flow advances to step 132 and tax payment is processed thereafter in the same manner as steps shown in FIG. 21. When the flow advances to step 142, the inputting of the player's personal information is performed (this step corresponding to the above-mentioned step 119), the win player performs the inputting of signature on a touch panel (the step corresponding to the above-mentioned step 20) in the succeeding step 143, and in step 144, an amount of money corresponding to the award after tax is paid out (the step corresponding to the above-mentioned step 108).

On the other hand, in the gaming server 100, the CPU 101 is operated in accordance with the control program stored in the ROM 102 and instructs the communication control part 105 to operate the communication processing part 106 and receives the taxation information “In” transmitted from the slot machine 1 via the network N. Further, the CPU 101 is operated as tax amount calculation means and adds up the tax amount information contained in the taxation information “In” with a predetermined unit (for example, every specific period such as one week, one month) so as to calculate the sum of the tax that a gaming arena where the slot machine 1 is installed has to pay (total tax payment amount). The calculated total tax payment amount is stored in the hard disc drive 104 and is used when the gaming arena performs the tax payment processing to the tax payment bureau when necessary.

As described above, according to this embodiment, in the slot machine 1, when the win which requires tax payment is generated, the slot machine 1 acquires the award after tax which is obtained by deducting the tax amount to be paid from the award, and the payout corresponding to the award after tax can be performed. Conventionally, when the win which requires tax payment is generated, the player has to wait for the payout for a long time due to the preparation of documents necessary for tax payment. According to the present invention, such a drawback can be made extremely small and hence, the slot machine 1 can continuously sustain the gaming interest imparted to the player without damaging the joy, the excitement and the like which are obtained by acquiring the big win.

Further, the conventional gaming machine is cumbersome with respect to a point that the player has to perform the procedures such as filling out his/her signature in necessary documents and the like after the attendant of the gaming arena arrives. On the other hand, the attendant of the gaming arena also feels cumbersomeness since the attendant has to prepare necessary documents and has to hand over the payout of the amount of money after the tax is deducted. To the contrary, according to the slot machine 1 of this embodiment, when the player wins the win which requires tax payment, the slot machine 1 automatically obtains the award after tax and performs the payout after the tax amount is deducted in advance before the payout (in accordance with the award after tax) and hence, tax payment is finished as if the win player performs tax payment by himself/herself. Accordingly, it is no more necessary for the win player to wait for the payment of the award only for the sake of tax payment before the win player receives the award and, at the same time, it is no more necessary for the win player to perform the cumbersome procedure such as filling out his/her signature in the necessary documents. Still further, the attendant of the gaming arena is also released from the cumbersomeness that the attendant has to hand over the award after deducting the tax amount. In this manner, the procedures necessary for tax payment is simplified for both of the win player and the attendant of the gaming arena.

On the other hand, in performing the above-mentioned automatic tax payment, the slot machine 1 allows the player to select the tax payment method and performs the automatic tax payment only when the player expresses his/her will of paying tax in accordance with the automatic tax payment by replying the selection request. Accordingly, there is no case that the slot machine 1 deducts the tax amount against the will of the player. Further, the player can confirm in advance the tax amount that the player has to pay by himself/herself and the award that the player can receive prior to tax payment and hence, the player is released from the fear that the tax is deducted by the slot machine 1 without the player's permission.

Further, in performing the automatic tax payment, the taxation conditions which are suitable for individual player are determined and the tax amount and the tax payment method are determined in accordance with the taxation conditions and hence, it is possible to perform the proper taxation. The taxation conditions in this case may be substantially equal to the taxation conditions for the manual tax payment.

Here, although the touch panel 56 is used to allow the player to input the player's personal information to the CPU 32 in the above-mentioned embodiment, a card reader may be provided along with the touch panel 56 and the card reader may read the player's personal information from a card which stores the player's personal information and may input the player's personal information to the CPU 32. The taxation conditions may be determined based on the player's personal information. Further, a passport reader may be provided along with the touch panel 56 and a passport reader reads a content of a passport and determines the taxation conditions based on a nationality of the player.

(Modification of Operational Content of Gaming System)

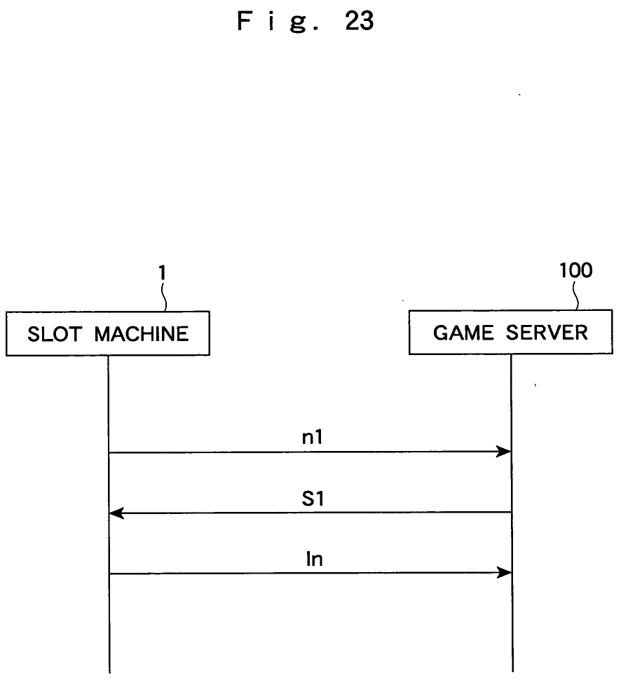

Then, in the above-mentioned embodiment, the taxation conditions are determined in the slot machine 1. Besides this mode, it may be possible to adopt a mode in which a program necessary for determination of taxation conditions is installed in the gaming server 100 (condition determination means being provided to the gaming server 100), the player's personal information is transmitted to the gaming server 100 from the slot machine 1, and the taxation conditions are determined in the gaming server 100. In this case, the slot machine 1 and the gaming server 100 perform the transmission/reception of information “In” accordance with steps shown in FIG. 23.

The slot machine 1 transmits the player's personal information n1 inputted in step 119 to the gaming server 100 by means of the communication processing part 42.

In the gaming server 100, when the communication processing part 106 receives the player's personal information n1, the CPU 101 is operated as the condition determination means and determines the taxation conditions in accordance with the substantially same steps as step 121 based on the player's personal information n1, and the taxation condition information s1 indicative of the determined taxation conditions is generated and is transmitted to the slot machine 1.

Next, in the slot machine 1, when the communication processing part 42 is operated as reception means and receives the taxation condition information s1, the main CPU 32 calculates the tax amount to be paid and the like in the substantially same manner as step 122. Further, the main CPU 32 generates the taxation information “In” in the substantially same manner as step 126 and transmits the taxation information “In” to the gaming server 100.

Further, upon receiving the taxation information “In”, the gaming server 100 performs the calculation of the total amount of tax payment and the like in the same manner as the above-mentioned embodiment.

Conventionally, when the win which requires tax payment is generated, the player has to wait for the payout for a long time due to the preparation of documents necessary for tax payment. According to the present invention, such a drawback can be made extremely small and, further, the tax amount is determined based on the taxation conditions and hence, the proper taxation is performed. Further, the determination of the taxation conditions is performed by the gaming server and hence, it is possible to reduce a burden imposed on the slot machine 1.

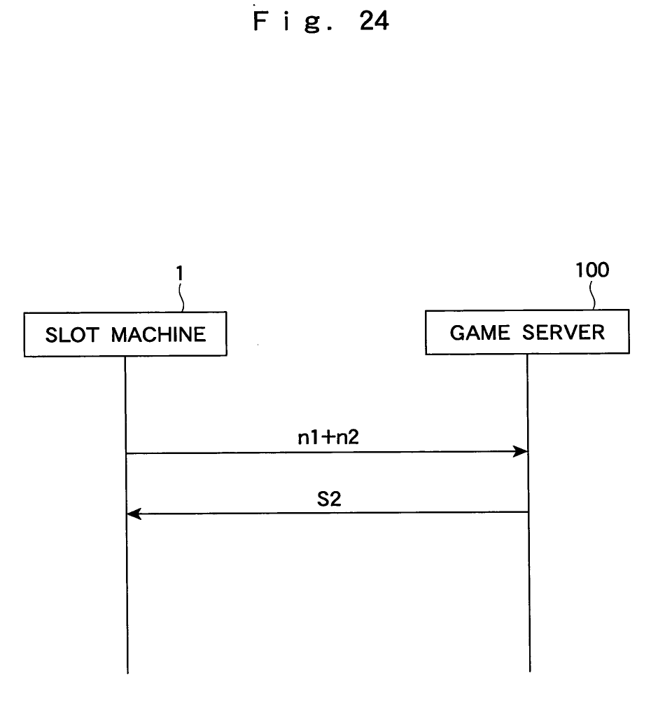

Still further, in addition to the installation of the program necessary for the determination of the taxation conditions in the gaming server 100, by installing a program necessary for the calculation of the tax amount and the award after tax in the gaming server 100, the award information indicative of the award which becomes big winnings may be transmitted to the gaming server 100 from the slot machine 1 and the calculation of the tax amount and the award after tax may be calculated in the gaming server 100. In this case, the slot machine 1 and the gaming server 100 perform the transmission/reception of the information “In” accordance with the procedure shown in FIG. 24.

The slot machine 1 transmits the player's personal information n1 inputted in step 119 and the award information n2 indicative of the award for the winnings to the gaming server 100.

Next, in the gaming server 100, when the communication processing part 106 receives the player's personal information n1 and the award information n2, the CPU 101 is operated as the condition determination means and determines the taxation conditions in the same manner as the step 121 based on the player's personal information n1.

Further, in the gaming server 100, the CPU 101 is operated as the withholding tax means and, in accordance with the determined taxation conditions, obtains the tax amount corresponding to the award which the received award information n2 indicates and the award after tax which is obtained by deducting the tax amount from the award and generates the withholding tax information s2 including the tax amount and the award after tax. Further, the communication processing part 106 transmits the generated withholding tax information s2 to the slot machine 1, while the calculation of the total amount of tax payment is performed in the same manner as the above-mentioned embodiment based on the generated withholding tax information s2.

On the other hand, in the slot machine 1, when the communication processing part 42 is operated as reception means and receives the withholding tax information s2 from the gaming server 100, the processing in steps after step 123 is executed based on the received withholding tax information s2.

Conventionally, when the win which requires tax payment is generated, the player has to wait for the payout for a long time due to the preparation of documents necessary for tax payment. According to the present invention, such a drawback can be made extremely small and, further, the tax amount or the like is determined based on the taxation condition and hence, the proper taxation is performed. Further, the determination of the tax conditions and the calculation of the award after tax are performed by the gaming server and hence, it is possible to reduce a burden imposed on the slot machine 1.

Here, although the above-mentioned embodiment has been explained with respect to the example in which the slot machine is used as the gaming machine, this embodiment is not limited to the slot machine and is applicable to the card gaming machine and other gaming machine which performs the payout of the award corresponding to a content of the win of the game.

1. A gaming machine which pays out an award to a player corresponding to a win of a game, the gaming machine comprising:
win approval/disapproval determination means which determines an approval or a disapproval of the win of the game;
tax payment requirement determination means which determines the necessity of tax payment on the win which is approved by the win approval/disapproval determination means; and
withholding tax means which deducts an amount of tax corresponding to the award corresponding to the win from the award when tax payment requirement determination means determines that tax payment is necessary.

2. A gaming machine according to claim 1, wherein the gaming machine is a slot machine.

3. A gaming machine according to claim 1, wherein the gaming machine further includes selection means which allows the player to select between tax payment using the withholding tax means and tax payment without using the withholding tax means.

4. A gaming machine according to claim 1, wherein the gaming machine further includes tax paying will inputting means which allows the player to input his/her will to pay the tax using the withholding tax means.

5. A gaming machine according to claim 1, wherein the gaming machine includes player's information generation means which generates the player's information for recording the player who pays tax using the withholding tax means, and player's information storage means which stores the player's information generated by the player's information generation means.

6. A gaming machine according to claim 1 or 2, wherein the gaming machine further includes tax amount information outputting means which outputs tax information indicative of the amount of tax corresponding to the award.

7. A gaming machine according to claim 1, wherein the gaming machine further includes tax rate setting means which sets a tax rate for obtaining the amount of tax corresponding to the award, and the withholding tax means requests the amount of tax using the tax rate set by the tax rate setting means.

8. A gaming machine according to claim 1, wherein the gaming machine further includes tax rate setting means which sets a tax rate for obtaining the amount of tax corresponding to the award, and the tax rate setting means gradually increases the tax rate corresponding to the increase of the award.

9. A gaming system which is constituted by connecting a gaming machine which pays out an award to a player corresponding to a win of a game and a gaming server, the gaming machine comprising:
win approval/disapproval determination means which determines an approval or a disapproval of the win of the game;
tax payment requirement determination means which determines the necessity of tax payment on the win which is approved by the win approval/disapproval determination means;
withholding tax means which deducts an amount of tax corresponding to the award corresponding to the win from the award when tax payment requirement determination means determines that the payment is necessary; and
transmission means which transmits tax amount information indicative of a tax amount corresponding to the award to a gaming server,
wherein the gaming server includes
tax amount information reception means which receives tax amount information from the gaming machine, and
tax amount calculation means which calculates a tax payment amount based on the tax amount information which is received by the tax amount information reception means.

10. A gaming system according to claim 9, wherein the gaming machine further includes tax rate setting means which sets a tax rate for obtaining the amount of tax corresponding to the award, and
the withholding tax means requests the amount of tax using the tax rate set by the tax rate setting means.

11. A gaming system according to claim 9, wherein the gaming machine includes tax rate setting means which sets a tax rate for obtaining the amount of tax corresponding to the award, and
the tax rate setting means gradually increases the tax rate corresponding to the increase of the award.

12. A gaming system according to claim 9, wherein the gaming machine is a slot machine.

13. A gaming system according to claim 9, wherein taxation condition information is transmitted to the gaming machine from the gaming server and the withholding tax means deducts the amount of tax corresponding to the award corresponding to the win from the award in accordance with the taxation condition information.

14. A gaming system according to claim 9, wherein the gaming machine transmits player's personal information and award information to the gaming server, the gaming server determines the taxation condition based on the player's personal information, and the withholding tax means obtains a tax amount corresponding to the award indicated by the award information and the award after tax which is obtained by deducting the amount of tax from the award in accordance with the taxation condition.
